(19) United States
(12) Patent Application Publication
(10) Pub. No.: US 2013/0005568 A1
(43) Pub. Date: Jan. 3, 2013

(54) SAFENED HERBICIDAL MIXTURES

(75) Inventors: Stephen Douglas Strachan, Oxford, PA (US); Kanu Maganbhai Patel, Wilmington, DE (US); Mark S. Casini, (US); Gale G. Casini, Elkton, MD (US)

(73) Assignee: E.I. DU PONT DE NEMOURS AND COMPANY, Wilmington, DE (US)

(21) Appl. No.: 13/445,129

(22) Filed: Apr. 12, 2012

Related U.S. Application Data
(60) Provisional application No. 61/503,065, filed on Jun. 30, 2011.

(51) Int. Cl. A01N 25/32; A01C 1/06

(52) U.S. Cl. 504/100; 504/111

(57) ABSTRACT

Disclosed are herbicidal mixtures comprising at least one compound selected from N-(aminocarbonyl)-2-methylbenzenesulfonamide and salts thereof, and at least one herbicide compound selected from acetohydroxy acid synthase inhibitors, auxin mimics, 4-hydroxyphenyl-pyruvate dioxygenase inhibitors, and salts thereof, and methods for controlling undesired vegetation comprising contacting the locus of the vegetation with a herbicidally effective amount of the mixtures. Also disclosed are compositions containing at least one compound selected from N-(aminocarbonyl)-2-methylbenzenesulfonamide and salts thereof, and propagules treated with an antidotally effective amount of at least one compound selected from N-(aminocarbonyl)-2-methylbenzenesulfonamide. Further disclosed are methods for protecting a propagule or plant from herbicide injury comprising applying to the propagule or plant an antidotally effective amount of at least one compound selected from N-(aminocarbonyl)-2-methylbenzenesulfonamide and salts thereof.

### FIELD OF THE INVENTION

This invention relates to herbicidal mixtures comprising combination of a safener compound with herbicides selected from certain herbicide classes, to compositions comprising the safener compound, to propagules treated with the safener compound, and to methods for controlling undesirable vegetation.

### BACKGROUND OF THE INVENTION

The control of undesired vegetation (i.e. weeds) is extremely important in achieving high crop efficiency. In commercial agriculture, this control is generally most economically achieved through application of herbicides, such as those of the herbicide classes known as acetohydroxy acid synthase inhibitors, auxin mimics and 4-hydroxyphenyl-pyruvate dioxygenase inhibitors. However, while herbicidal compounds capable of selective weed control in crops have been discovered, their selectivity is not always sufficient to effectively control particular troublesome weed species and biotypes while avoiding excessive injury to the crops. Crop tolerance to herbicide injury can vary not only according to crop plant species but also variety. Some crop varieties are more susceptible to herbicide injury, but nevertheless have other agronomically desirable traits. Crop tolerance to herbicides can vary with growth stage of crop plants and be diminished by environmental factors affecting growing conditions. Although herbicide resistance can be incorporated in crop plants by such techniques as mutagenesis and selection, transgenic modification and conventional plant breeding, the herbicide tolerance obtained still may not always be sufficient to avoid excessive injury from herbicides at application rates needed to satisfactorily control particular weeds in the crop.

One method for improving the selectivity of a herbicide applied to the locus of a crop is applying the herbicide in combination (e.g., admixture) with a compound capable of increasing the tolerance of the crop plants more than the tolerance of the weeds to the herbicide. Such compounds increasing tolerance to herbicides are described as “antidotes” or “safeners”. An economic disadvantage of this method is that applying a safener in combination with a herbicide increases the cost of the weed control treatment. This disadvantage can be mitigated if the safener compound is highly active as an antidote and has a molecular structure amenable to low-cost manufacture. Only relatively few compounds demonstrate substantial activity as herbicide safeners, and high activity for safening commercially important herbicides in agronomic crops is rarer still. Achieving agronomically useful safening from combination of a herbicide with a safener compound having a relatively simple molecular structure amenable to low-cost manufacture presents even a greater challenge. Nevertheless, such herbicide-safener combinations have now been discovered.

U.S. Pat. No. 4,645,527 discloses certain herbicide-safener combinations, but not those of the present invention.

### SUMMARY OF THE INVENTION

This invention is directed to a herbicidal mixture comprising (a) at least one compound selected from N-(aminocarbonyl)-2-methylbenzenesulfonamide (Formula 1) and salts thereof,

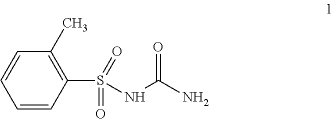

and (b) at least one herbicide compound selected from (b1) acetohydroxy acid synthase inhibitors, (b2) auxin mimics, (b3) 4-hydroxyphenyl-pyruvate dioxygenase inhibitors, and salts of compounds of (b1) through (b3).

This invention also relates to a herbicidal composition comprising the aforesaid herbicidal mixture and at least one component selected from the group consisting of surfactants, solid diluents and liquid diluents. This invention further relates to a method for controlling the growth of undesired vegetation comprising contacting the locus of the vegetation (e.g., the vegetation or its environment) with a herbicidally effective amount of the aforesaid herbicidal mixture (e.g., as a composition described herein).

An aspect of the present method relates to a method for selectively controlling undesired vegetation wherein the locus of the undesired vegetation is a crop. A related aspect of said method relates to selectively controlling undesired vegetation in a crop containing at least one genetic trait providing resistance to herbicides inhibiting acetohydroxy acid synthase.

This invention is also directed to a herbicide safener composition comprising at least one compound selected from N-(aminocarbonyl)-2-methylbenzenesulfonamide and salts thereof, and at least one component selected from the group consisting of surfactants, solid diluents and liquid diluents. This invention also relates to a method for protecting a plant from herbicide injury (e.g., injury caused by (b1), (b2) or (b3)) comprising applying an antidotally effective amount of at least one compound selected from N-(aminocarbonyl)-2-methylbenzenesulfonamide and salts thereof to the plant or the locus of the plant. This invention also relates to a method for protecting a propagule or a plant grown therefrom from herbicide injury (e.g., injury caused by (b1), (b2) or (b3)) by treating the propagule with an antidotally effective amount of at least one compound selected from N-(aminocarbonyl)-2-methylbenzenesulfonamide and salts thereof, and to a propagule treated with an antidotally effective amount of at least one compound selected from N-(aminocarbonyl)-2-methylbenzenesulfonamide and salts thereof (e.g., in a herbicide safener composition described herein).

### DETAILS OF THE INVENTION

As used herein, the terms “comprises,” “comprising,” “includes,” “including,” “has,” “having,” “contains”, “containing,” “characterized by” or any other variation thereof, are intended to cover a non-exclusive inclusion, subject to any limitation explicitly indicated. For example, a composition, mixture, process or method that comprises a list of elements is not necessarily limited to only those elements but may include other elements not expressly listed or inherent to such composition, mixture, process or method.

The transitional phrase “consisting of” excludes any element, step, or ingredient not specified. If in the claim, such would close the claim to the inclusion of materials other than those recited except for impurities ordinarily associated therewith. When the phrase “consisting of” appears in a clause of the body of a claim, rather than immediately following the preamble, it limits only the element set forth in that clause; other elements are not excluded from the claim as a whole.

The transitional phrase “consisting essentially of” is used to define a composition or method that includes materials, steps, features, components, or elements, in addition to those literally disclosed, provided that these additional materials, steps, features, components, or elements do not materially affect the basic and novel characteristic(s) of the claimed invention. The term “consisting essentially of” occupies a middle ground between “comprising” and “consisting of”.

Where applicants have defined an invention or a portion thereof with an open-ended term such as “comprising,” it should be readily understood that (unless otherwise stated) the description should be interpreted to also describe such an invention using the terms “consisting essentially of” or “consisting of”.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Also, the indefinite articles “a” and “an” preceding an element or component of the invention are intended to be nonrestrictive regarding the number of instances (i.e. occurrences) of the element or component. Therefore “a” or “an” should be read to include one or at least one, and the singular word form of the element or component also includes the plural unless the number is obviously meant to be singular.

In the context of the present disclosure and claims, “component (a)” refers to “at least one compound selected from N-(aminocarbonyl)-2-methylbenzenesulfonamide (Formula 1) and salts thereof”, and “component (b)” refers to “at least one herbicide compound selected from (b1) acetohydroxy acid synthase inhibitors, (b2) auxin mimics, (b3) 4-hydroxyphenyl-pyruvate dioxygenase inhibitors, and salts of compounds of (b1) through (b3)”.

As referred to herein, the term “crop”, used alone or in a combination of words, refers to one or more spatially grouped plants of an agriculturally, horticulturally or otherwise economically desired plant species. Crops thus include annual row crops as wheat, barley, oats, maize (corn), rice, sorghum, sunflower, soybeans, cotton, rape, sugar beets and tomato, potato and other vegetables, perennial crops that are harvested such as coffee, cocoa, oil palm, rubber, sugarcane, citrus, grapes, fruit trees, nut trees, banana, plantain, pineapple, hops, tea and forests such as eucalyptus (e.g., loblolly pine) or consumed as fodder such alfalfa and pasture grasses, and plant species having ornamental or other economic value such as turf grasses. The term “weed” refers to undesired plant species or vegetation.

As referred to herein, the term “seedling”, used either alone or in a combination of words, means a young plant developing from the embryo of a seed.

As referred to herein, the term “broadleaf” used either alone or in words such as “broadleaf weed” means dicot or dicotyledon, a term used to describe a group of angiosperms characterized by embryos having two embryonic seed leaves or cotyledons. The term monocot refers to a group of angiosperms characterized by embryos having only one embryonic seed leaf or cotyledon. Monocot crops include grass crops.

As referred to in the present disclosure and claims, the term “propagule” means a seed or a regenerable plant part. The term “regenerable plant part” means a part of a plant other than a seed from which a whole plant may be grown or regenerated when the plant part is placed in horticultural or agricultural growing media such as moistened soil, peat moss, sand, vermiculite, perlite, rock wool, fiberglass, coconut husk fiber, tree fern fiber and the like, or even a completely liquid medium such as water. Regenerable plant parts commonly include rhizomes, tubers, bulbs and corms of such geophytic plant species as potato, sweet potato, yam, onion, dahlia, tulip, narcissus, etc. Regenerable plant parts include plant parts that are divided (e.g., cut) to preserve their ability to grow into a new plant. Therefore regenerable plant parts include viable divisions of rhizomes, tubers, bulbs and corms which retain meristematic tissue, such as an eye. Regenerable plant parts can also include other plant parts such as cut or separated stems (e.g., sugarcane stem cuttings) or leaves from which some species of plants can be grown using horticultural or agricultural growing media. As referred to in the present disclosure and claims, unless otherwise indicated, the term “seed” includes both unsprouted seeds and sprouted seeds in which the testa (seed coat) still surrounds part of the emerging shoot and root.

One skilled in the art recognizes that because in the environment and under physiological conditions salts of chemical compounds are in equilibrium with their corresponding nonsalt forms, salts share the biological utility of the nonsalt forms. Thus in the present herbicidal mixture and composition, a wide variety of salts of the compound of Formula 1 (component (a)) as well as the herbicide compounds of component (b) are useful for control of undesired vegetation (i.e. are agriculturally suitable). The salts of the compound of Formula 1 as well as herbicide compounds of component (b) when they contain an acidic moiety such as a sulfonylurea or carboxylic acid include those formed with organic or inorganic bases such as pyridine, triethylamine or ammonia, or amides, hydrides, hydroxides or carbonates of sodium, potassium, lithium, calcium, magnesium or barium. The salts of the compound of Formula 1 and herbicide compounds of component (b) when they contain a basic moiety such as an amine also include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. Accordingly, the present invention comprises herbicidal mixtures and compositions comprising (a) a compound selected from Formula 1 and agriculturally suitable salts thereof, and (b) at least one herbicide compound selected from (b1) acetohydroxy acid synthase inhibitors, (b2) auxin mimics, (b3) 4-hydroxyphenyl-pyruvate dioxygenase inhibitors, and agriculturally suitable salts of compounds of (b1) through (b3).

Embodiments of the present invention as described in the Summary of the Invention include (where Formula 1 and (b1) acetohydroxy acid synthase inhibitors, (b2) auxin mimics and (b3) 4-hydroxyphenyl-pyruvate dioxygenase inhibitors referred to in the following Embodiments includes salts thereof):
Embodiment 1. The (herbicidal) mixture described in the Summary of the Invention wherein component (b) comprises at least one herbicide compound selected from (b1) acetohydroxy acid synthase inhibitors.
Embodiment 2. The mixture of Embodiment 1 wherein component (b) comprises at least one herbicide compound selected from sulfonylurea herbicides.
Embodiment 3. The mixture of Embodiment 2 wherein component (b) comprises at least one herbicide compound selected from chlorimuron-ethyl, flupyrsulfuron-methyl, metsulfuron-methyl, nicosulfuron, rimsulfuron, sulfometuron-methyl and thifensulfuron-methyl, and salts thereof.
Embodiment 4. The mixture of Embodiment 3 wherein component (b) comprises chlorimuron-ethyl or a salt thereof.
Embodiment 5. The mixture of Embodiment 3 or 4 wherein component (b) comprises flupyrsulfuron-methyl or a salt thereof.
Embodiment 6. The mixture of any one of Embodiments 3 through 5 wherein component (b) comprises metsulfuron-methyl or a salt thereof.
Embodiment 7. The mixture of any one of Embodiments 3 through 6 wherein component (b) comprises nicosulfuron or a salt thereof.
Embodiment 8. The mixture of any one of Embodiments 3 through 7 wherein component (b) comprises rimsulfuron or a salt thereof.
Embodiment 9. The mixture of any one of Embodiments 3 through 8 wherein component (b) comprises sulfometuron-methyl or a salt thereof.
Embodiment 10. The mixture of any one of Embodiments 3 through 9 wherein component (b) comprises thifensulfuron-methyl or a salt thereof.
Embodiment 11. The (herbicidal) mixture described in the Summary of the Invention or any one of Embodiments 1 through 10 wherein component (b) comprises at least one herbicide compound selected from (b2) auxin mimics.
Embodiment 12. The mixture of Embodiment 11 wherein component (b) comprises a least one herbicide compound selected from aminocyclopyrachlor and its esters, and dicamba, and salts thereof.
Embodiment 13. The mixture of Embodiment 12 wherein component (b) comprises at least one compound selected from aminocyclopyrachlor and its esters, and salts thereof.
Embodiment 14. The mixture of Embodiment 12 or 13 wherein component (b) comprises dicamba or a salt thereof.
Embodiment 15. The (herbicidal) mixture described in the Summary of the Invention or any one of Embodiments 1 through 14 wherein component (b) comprises at least one herbicide compound selected from (b3) 4-hydroxyphenyl-pyruvate dioxygenase inhibitors.
Embodiment 16. The mixture of Embodiment 15 wherein component (b) comprises at least one herbicide compound selected from mesotrione, tembotrione and bicyclopyrone, and salts thereof.

Embodiments also include Embodiments 17-32 drawn to a herbicidal composition described in the Summary of the Invention wherein component (b) is as specified in Embodiments 1 through 16, respectively. Embodiments also include Embodiments 33-48 drawn to a method for controlling undesired vegetation described in the Summary of the Invention wherein component (b) is as specified in Embodiments 1 through 16, respectively. Embodiments further include the following embodiments:
Embodiment 49. The method for controlling undesired vegetation described in the Summary of the Invention or any one of Embodiments 33-48 wherein the locus of the undesired vegetation is a crop.
Embodiment 50. The method of Embodiment 49 wherein the crop is a grass (i.e. graminaceous) crop.
Embodiment 51. The method of Embodiment 49 wherein the crop is a broadleaf crop.
Embodiment 52. The method of Embodiment 49 wherein the crop is selected from alfalfa, barley, cotton, wheat, rape, sugar beets, maize (corn), sorghum, soybeans, sunflower, rice, oats, peanuts, vegetables, tomato, potato, perennial plantation crops including coffee, cocoa, oil palm, rubber, sugarcane, citrus, grapes, fruit trees, nut trees, banana, plantain, pineapple, hops, tea and forests such as eucalyptus and conifers (e.g., loblolly pine), pasture grasses (e.g., Brachiaria spp. such as B. decumbens Stapf., B. brizantha Hochst. ex A. Rich and B. plantaginea (Link) A. S. Hitchc.) and turf grasses (e.g., Poa pratensis L., Stenotaphrum secundatum (Walt.) Kuntze, Festuca spp. including Festuca arundinacea Shreib. and hard fescue, Agrostis stoonoifera L., Lolium perenne L., Kentucky fescue and Cynodon dactylon (L.) Pers., Zoysia japonica Steud.).
Embodiment 53. The method of Embodiment 52 wherein the crop is selected from wheat, barley, maize, sorghum, soybeans, sunflower, sugarcane, pasture grasses and turf grasses.
Embodiment 54. The method of Embodiment 53 wherein the crop is maize.
Embodiment 55. The method of Embodiment 53 wherein the crop is sorghum.
Embodiment 56. The method of Embodiment 55 wherein the sorghum contains a gene providing resistance to acetohydroxy acid synthase-inhibiting herbicides.
Embodiment 57. The method of Embodiment 53 wherein the crop is selected from wheat and barley.
Embodiment 58. The method of Embodiment 53 wherein the crop is selected from turf grasses.
Embodiment 59. The method of Embodiment 58 wherein the turf grasses are selected from Agrostis, Cynodon, Festuca, Lolium and Zoysia species.
Embodiment 60. The method of Embodiment 59 wherein the turf grasses are selected from zoysia, bermudagrass, tall fescue, creeping bentgrass, perennial ryegrass and hard fescue.
Embodiment 61. The method of Embodiment 53 wherein the crop is sunflower.
Embodiment 62. The method of Embodiment 61 wherein the sunflower is a variety bred for resistance to tribenuron-methyl.
Embodiment 63. The method of Embodiment 53 wherein the crop is soybeans.
Embodiment 64. The method of Embodiment 53 wherein the crop is sugarcane.
Embodiment 65. The method of Embodiment 53 wherein the crop is selected from pasture grasses.
Embodiment 66. The method of Embodiment 65 wherein the pasture grasses are Brachiaria species.
Embodiment 67. The method of Embodiment 66 wherein the pasture grasses are selected from Surinam grass, palisade grass and Alexandergrass.

Embodiments further include Embodiments 68 through 86 relating to a method for protecting a plant from herbicide injury as described in the Summary of the Invention wherein the plant is a crop as described in Embodiments 49 through 67, respectively.

Embodiments further include Embodiment 87 relating to a method for protecting a propagule or plant grown therefrom from herbicide injury as described in the Summary of the Invention wherein the propagule is a seed.

Embodiments further include Embodiments 88 through 106 relating to a method for protecting a propagule or a plant grown therefrom from herbicide injury as described in the Summary of the Invention or Embodiment 87, wherein the propagule is of a crop as described in Embodiments 49 through 67, respectively.

Embodiments further include Embodiment 107 relating to a treated propagule as described in the Summary of the Invention wherein the propagule is a seed.

Embodiments further include Embodiments 108 through 126 relating to a treated propagule as described in the Summary of the Invention or Embodiment 107, wherein the propagule is of a crop as described in Embodiments 49 through 67, respectively.

Embodiments of this invention, including Embodiments 1-126 above as well as any other embodiments described herein, can be combined in any manner.

The compound N-(aminocarbonyl)-2-methylbenzenesulfonamide (Formula 1) and its salts have now been discovered to be unexpectedly extraordinarily effective for safening herbicides of the acetohydroxy acid synthase inhibitor, auxin mimic, and 4-hydroxyphenyl-pyruvate dioxygenase inhibitor classes of herbicides on a wide variety of both monocot and dicot crops while retaining efficacy of the herbicides in controlling agronomically important weeds.

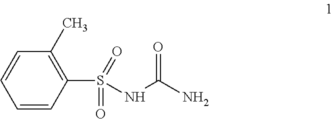

Therefore the present invention relates to combination of (a) at least one compound selected from N-(aminocarbonyl)-2-methylbenzenesulfonamide and salts thereof, with (b) at least one herbicide compound selected from (b1) acetohydroxy acid synthase inhibitors, (b2) auxin mimics, (b3) 4-hydroxyphenyl-pyruvate dioxygenase inhibitors, including salts thereof. This combination can be in the form of a herbicidal mixture comprising components (a) and (b), or a herbicidal composition comprising the components (a) and (b) and at least one component selected from the group consisting of surfactants, solid diluents and liquid diluents. In this combination, mixture and composition, component (a) is present in an antidotally effective amount, and component (b) is present in a herbicidally effective amount.

The present invention also provides a herbicide safener composition comprising at least one compound selected from N-(aminocarbonyl)-2-methylbenzenesulfonamide and salts thereof (i.e. in an antidotally effective amount), and at least one component selected from the group consisting of surfactants, solid diluents and liquid diluents. The herbicide safener composition can be applied in an antidotally effective amount to a plant or the locus of the plant to protect the plant from injury caused by herbicidal compounds (e.g., selected from acetohydroxy acid synthase inhibitors, auxin mimics and 4-hydroxyphenyl-pyruvate dioxygenase inhibitors, including salts thereof).

The herbicide safener composition can also be used to treat a propagule to protect the propagule or plant grown therefrom from herbicide injury. Typically a herbicide safener composition used to treat a propagule comprises at least one component selected from surfactants, solid diluents and liquid diluents that is a film former and/or adhesive agent. Accordingly, one embodiment of a herbicide safener composition comprising at least one compound selected from N-(aminocarbonyl)-2-methylbenzenesulfonamide and salts thereof and at least one component selected from the group consisting of surfactants, solid diluents and liquid diluents is a herbicide safener composition comprising at least one compound selected from N-(aminocarbonyl)-2-methylbenzenesulfonamide and salts thereof and at least one component selected from film formers and adhesive agents.

Also provided is a method for controlling the growth of undesired vegetation comprising contacting the vegetation or its environment (e.g., the locus of a crop) with a herbicidally effective amount of aforesaid herbicidal mixture (e.g., as a herbicidal composition comprising a surfactant or solid or liquid diluent). The combination of components (a) and (b) can be provided and the herbicidal mixture or composition formed by admixture before application or by separate (e.g., successive) application to the undesired vegetation or its environment (e.g., the locus of a crop) of components (a) and (b) (e.g., in compositions separately containing components (a) and (b)). Alternatively, component (a) (e.g., in a composition) can be applied, in an antidotally effective amount, to a propagule (e.g., seed, tuber, bulb or rhizome) of a crop followed by application, in a herbicidally effective amount, of component (b) to the locus of the crop plant. A particularly useful embodiment of the present invention is a method for selectively controlling the growth of undesired vegetation in a crop comprising contacting the locus of the crop with a herbicidally effective amount of herbicide component (b) wherein a propagule, especially a seed, from which the crop is grown is treated with an antidotally effective amount of safener component (a).

The compound of Formula 1 can be prepared by known methods from the compound of Formula 2, as described in J. Med. Chem. 1979, 22, 90-93 and U.S. Pat. No. 2,385,571. As illustrated in Scheme 1, in one method, a mixture of the compound of Formula 2 and potassium cyanate or sodium cyanate in a lower alkanol (e.g., ethanol or methanol) containing 1-20% water is heated at reflux for 1-24 h to provide the compound of Formula 1.

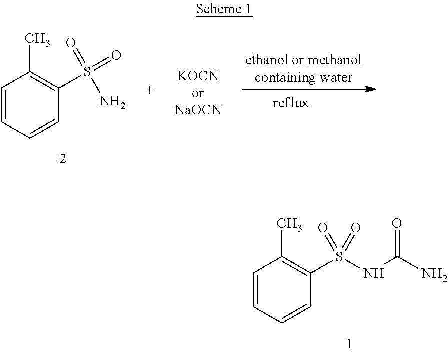

Without further elaboration, it is believed that one skilled in the art using the preceding description can prepare the compound of Formula 1 and salts thereof to practice the present invention to its fullest extent. The following Synthesis Example is, therefore, to be construed as merely illustrative, and not limiting of the disclosure in any way whatsoever. ¹H NMR spectra are reported in ppm downfield from tetramethylsilane; “s” means singlet, “m” means multiplet, and “br s” means broad singlet. Mass spectra (MS) are reported as the molecular weight of the highest isotopic abundance parent ion (M+1) formed by addition of H⁺ (molecular weight of 1) to the molecule, observed by mass spectrometry using atmospheric pressure chemical ionization (AP⁺) where “amu” stands for atomic mass units.

### SYNTHESIS EXAMPLE 1

### Preparation of N-(aminocarbonyl)-2 methylbenzenesulfonamide

A suspension of 2-methylbenzenesulfonamide (34.4 g, 0.2 mol) and potassium cyanate (18.8 g, 0.232 mol) in a mixture of ethanol (272 mL) and water (34 mL) was heated at reflux for 18 h. The mixture was then cooled to room temperature and concentrated by rotary evaporation. The residual solid was suspended in water (50 mL), and acetic acid (35 mL) was added dropwise over 10 minutes. The mixture was stirred for an additional 15 minutes, and the solids were collected by filtration. The solids were washed with water (100 mL), followed by hexane (50 mL), and dried under vacuum for 24 h. The solids were then suspended in a mixture of dichloromethane and acetonitrile (1:1 by volume, 50 mL), and the suspension was filtered to collect solids. The solids were dried under vacuum to provide the title compound as a white solid (22 g), melting at 179-180 ° C.

¹H NMR (DMSO-d₆) δ 10.8 (br s, 1H), 7.9 (m, 1H), 7.5 (m, 1H), 7.35(m, 2H), 5.9 (br s, 2H), 2.5 (s, 3H).

MS 214 (M), 215 (M+1) amu.

The herbicide classes providing component (b) in the present invention, i.e. (b1) acetohydroxy acid synthase inhibitors, (b2) auxin mimics, (b3) 4-hydroxyphenyl-pyruvate dioxygenase inhibitors, and salts of compounds of (b1) through (b3), are well known in the art of weed control.

“Acetohydroxy acid synthase inhibitors” (b1) are chemical compounds that inhibit acetohydroxy acid synthase (AHAS), also known as acetolactate synthase (ALS), and thus kill plants by inhibiting the production of the branched-chain aliphatic amino acids such as valine, leucine and isoleucine, which are required for DNA synthesis and cell growth. Herbicides inhibiting AHAS inhibitors can be categorized into five chemical subclasses based on general molecular structure: sulfonylureas, sulfonylaminocarbonyltriazolinones, triazolopyrimidines, pyrimidinyl(thio)benzoates and imidazolinones. Each of these chemical subclasses is well known in the art.

Sulfonylurea herbicide molecules comprise a sulfonylurea moiety (—S(O)₂NHC(O)NH(R)—). In sulfonylurea herbicides the sulfonyl end of the sulfonylurea moiety is connected either directly or by way of an oxygen atom or an optionally substituted amino or methylene group to a typically substituted cyclic or acyclic group. At the opposite end of the sulfonylurea bridge, the amino group, which may have a substituent such as methyl (R being CH₃) instead of hydrogen, is connected to a heterocyclic group, typically a symmetric pyrimidine or triazine ring, having one or two substituents such as methyl, ethyl, trifluoromethyl, methoxy, ethoxy, methylamino, dimethylamino, ethylamino and the halogens. Sulfonylurea herbicides can be in the form of the free acid or a salt. In the free acid form the sulfonamide nitrogen on the bridge is not deprotonated (i.e. —S(O)₂NHC(O)NH(R)—), while in the salt form the sulfonamide nitrogen atom on the bridge is deprotonated (i.e. —S(O)₂N^{⊖}C(O)NH(R)—), and a cation is present, typically of an alkali metal or alkaline earth metal, most commonly sodium or potassium.

Representative of the sulfonylureas useful in the present invention are those of Formula 2 and salts thereof.

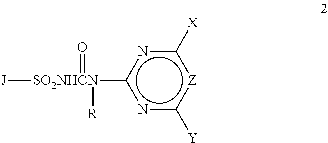

wherein:
J is selected from the group consisting of

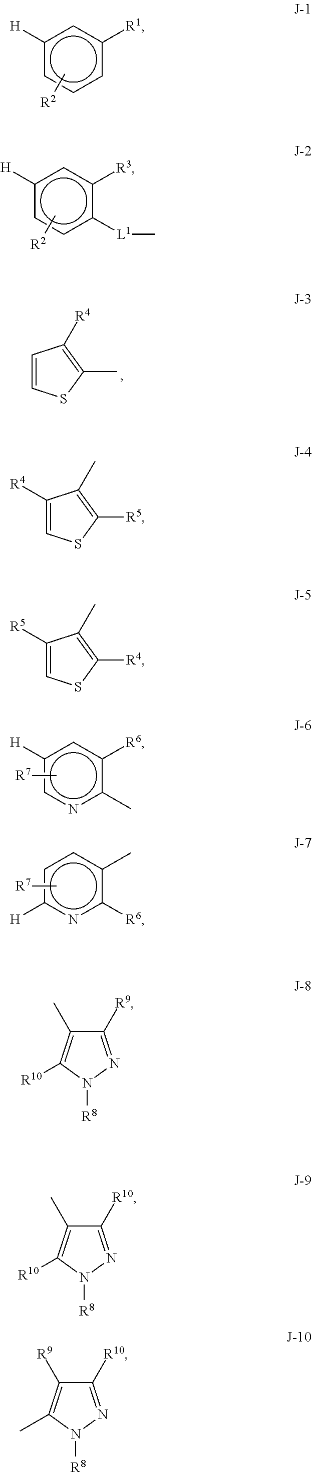

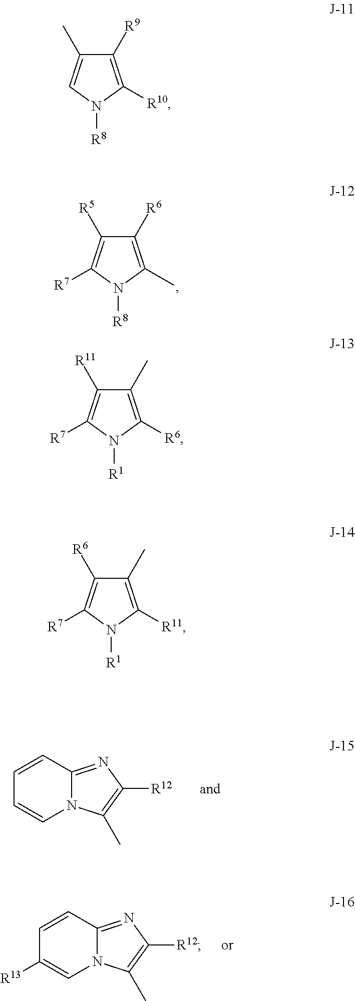

J is R¹⁴SO₂N(CH₃)—;
R is H or CH₃;
R¹ is F, Cl, Br, NO₂, C₁-C₄ alkyl, C₁-C₄ haloalkyl, C₃-C₄ cycloalkyl, C₂-C₄ haloalkenyl, C₁-C₄ alkoxy, C₁-C₄ haloalkoxy, C₂-C₄ alkoxyalkoxy, CO₂R¹⁵, C(O)NR¹⁶R¹⁷, SO₂NR¹⁸R¹⁹, S(O)ₙR²⁰, C(O)R²¹, —CH₂CN or L;
R² is H, F, Cl, Br, I, cyano, CH₃, CF₃, CH₂NHS(O)₂CH₃, OCH₃, OCF₂H, SCH₃ or NHCHO;
R³ is Cl, nitro, CO₂CH₃, CO₂CH₂CH₃, C(O)CH₃, C(O)CH₂CH₃, C(O)-cyclopropyl, C(O)N(CH₃)₂, SO₂N(CH₃)₂, SO₂CH₃, SO₂CH₂CH₃, OCH₃ or OCH₂CH₃;
R⁴ is C₁-C₃ alkyl, C₁-C₂ haloalkyl, C₁-C₂ alkoxy, C₂-C₄ haloalkenyl, F, Cl, Br, nitro, CO₂R¹⁵, C(O)NR¹⁶R¹⁷, SO₂NR¹⁸R¹⁹, S(O)ₙR²⁰, C(O)R²¹ or L;
R⁵ is H, F, Cl, Br or CH₃;
R⁶ is C₁-C₃ alkyl optionally substituted with up to 3 F, up to 1 Cl and up to 1 C₃-C₄ alkoxyacetyloxy, or R⁶ is C₁-C₂ alkoxy, C₁-C₂ haloalkoxy, C₂-C₄ haloalkenyl, F, Cl, Br, CO₂R¹⁵, C(O)NR¹⁶R¹⁷, SO₂NR¹⁸R¹⁹, S(O)ₙR²⁰, C(O)R²¹ or L;
R⁷ is H, F, Cl, CH₃ or CF₃;
R⁸ is H, C₁-C₃ alkyl or pyridinyl;
R⁹ is C₁-C₃ alkyl, C₁-C₂ alkoxy, F, Cl, Br, NO₂, CO₂R¹⁵, SO₂NR¹⁸R¹⁹, S(O)ₙR²⁰, OCF₂H, C(O)R²¹, C₂-C₄ haloalkenyl or L;
R¹⁰ is H, Cl, F, Br, C₁-C₃ alkyl or C₁-C₂ alkoxy;
R¹¹ is H, C₁-C₃ alkyl, C₁-C₂ alkoxy, C₂-C₄ haloalkenyl, F, Cl, Br, CO₂R¹⁵, C(O)NR¹⁶R¹⁷, SO₂NR¹⁸R¹⁹, S(O)ₙR²⁰, C(O)R²¹ or L;
R¹² is halogen, C₁-C₄ alkyl or C₁-C₃ alkylsulfonyl;
R¹³ is H or C₁-C₄ alkyl;
R¹⁴ is C₁-C₄ alkyl;
R¹⁵ is allyl, propargyl or oxetan-3-yl; or C₁-C₃ alkyl optionally substituted by up to 3 halogen, up to 1 C₁-C₂ alkoxy and up to 1 cyano;
R¹⁶ is H, C₁-C₃ alkyl or C₁-C₂ alkoxy;
R¹⁷ is C₁-C₂ alkyl;
R¹⁸ is H, C₁-C₃ alkyl, C₁-C₂ alkoxy, allyl or cyclopropyl;
R¹⁹ is H or C₁-C₃ alkyl;
R²⁰ is C₁-C₃ alkyl, C₁-C₃ haloalkyl, allyl or propargyl;
R²¹ is C₁-C₄ alkyl or C₁-C₄ haloalkyl; or C₃-C₅ cycloalkyl optionally substituted by halogen;
n is 0, 1 or 2;
L is

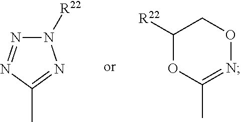

L¹ is CH₂, NH or O;
R²² is selected from the group H and C₁-C₃ alkyl;
X is selected from the group consisting of H, C₁-C₄ alkyl, C₁-C₄ alkoxy, C₁-C₄ haloalkoxy, C₁-C₄ haloalkyl, C₁-C₄ haloalkylthio, C₁-C₄ alkylthio, halogen, C₂-C₅ alkoxyalkyl, C₂-C₅ alkoxyalkoxy, amino, C₁-C₃ alkylamino and di(C₁-C₃ alkyl)amino;
Y is selected from the group consisting of H, C₁-C₄ alkyl, C₁-C₄ alkoxy, C₁-C₄ haloalkoxy, C₁-C₄ alkylthio, C₁-C₄ haloalkylthio, C₂-C₅ alkoxyalkyl, C₂-C₅ alkoxyalkoxy, amino, C₁-C₃ alkylamino, di(C₁-C₃ alkyl)amino, C₃-C₄ alkenyloxy, C₃-C₄ alkynyloxy, C₂-C₅ alkylthioalkyl, C₂-C₅ alkylsulfinylalkyl, C₂-C₅ alkylsulfonylalkyl, C₁-C₄ haloalkyl, C₂-C₄ alkynyl, C₃-C₅ cycloalkyl, azido and cyano; and
Z is selected from the group consisting of CH and N;
   provided that (i) when one or both of X and Y is C₁ haloalkoxy, then Z is CH; and (ii) when X is halogen, then Z is CH and Y is OCH₃, OCH₂CH₃, NHCH₃, N(CH₃)₂ or OCF₂H.

Examples of sulfonylurea herbicides include amidosulfuron, azimsulfuron, bensulfuron-methyl, chlorimuron-ethyl, chlorsulfuron, cinosulfuron, cyclosulfamuron, ethametsulfuron-methyl, ethoxysulfuron, flazasulfuron, flucetosulfuron, flupyrsulfuron-methyl (including sodium salt), foramsulfuron, halosulfuron-methyl, imazosulfuron, iodosulfuron-methyl (including sodium salt), mesosulfuron-methyl, metazosulfuron, metsulfuron-methyl, nicosulfuron, orthosulfamuron, oxasulfuron, primisulfuron-methyl, propyrisulfuron, prosulfuron, pyrazosulfuron-ethyl, rimsulfuron, sulfometuron-methyl, sulfosulfuron, thifensulfuron-methyl, triasulfuron, tribenuron-methyl, trifloxysulfuron (including sodium salt), triflusulfuron-methyl and tritosulfuron.

Sulfonylaminocarbonyltriazolinone herbicide molecules comprise a triazolinone moiety bonded through a —C(O)NHS(O)₂— bridge to a typically substituted cyclic group. The bridge can be deprotonated (e.g., by bases) to form salts (e.g., —C(O)N^{⊖}S(O)₂—). Examples of sulfonylaminocarbonyltriazolinone herbicides include flucarbazone (including sodium salt), propoxycarbazone (including sodium salt) and thiencarbazone-methyl.

Triazolopyrimidine herbicide molecules comprise a triazolopyrimidine moiety bonded to a —S(O)₂NH— bridge bonded at the other end to a typically substituted cyclic group. Deprotonation of the bridge (e.g., with bases) can form salts (e.g., —S(O)₂N^{⊖}—). Examples of triazolopyrimidine herbicides include cloransulam-methyl, diclosulam, florasulam, flumetsulam, metosulam, penoxsulam and pyroxsulam.

Pyrimidinyl(thio)benzoate herbicide molecules comprise pyrimidine ring bonded through an oxygen or sulfur atom to a benzene ring having a carboxylic acid or ester substituent. The carboxylic acid substituent can be deprotonated (e.g., by bases) to form salts. Examples of pyrimidinyl(thio)benzoate herbicides also identified as pyrimidinyl(thio)ether herbicides include bispyribac and its sodium salt (bispyribac-sodium), pyribenzoxim, pyriftalid, pyrithiobac and its sodium salt (pyrithiobac-sodium) and pyriminobac-methyl.

Imidazolinone herbicide molecules comprise an imidazolinone moiety. Examples of imidazolinone herbicides include imazapic, imazamethabenz-methyl, imazamox, imazapyr, imazaquin (including ammonium salt) and imazethapyr (including ammonium salt).

“Auxin mimics” (b2) also known as “synthetic auxins” are chemical compounds mimicking the plant growth hormone auxin, thus causing uncontrolled and disorganized growth leading to plant death in susceptible species. Auxin mimic herbicides are generally carboxylic acids, which may be in the form of salts (alkali or alkaline earth metal, or quaternary ammonium salts, or salts with amines) or esters with alkanols or alkanethiols (e.g., methyl or other lower alkyl esters) as biological equivalents. Herbicides acting as auxin mimics can be categorized into six chemical subclasses based on general molecular structure: benzoic acids, pyridinecarboxylic acids, pyrimidinecarboxylic acids, phenoxycarboxylic acids, quinolinecarboxylic acids and benzothiazolylacetic acids. Each of these chemical subclasses is well known in the art.

Benzoic acid herbicide molecules comprise a benzoic acid moiety. Examples of benzoic acid herbicides include chloramben, dicamba and 2,3,6-TBA. Dicamba can also be in the form of its salts (e.g., diglycolammonium, dimethylammonium, potassium or sodium).

Pyridinecarboxylic acid herbicide molecules comprise a pyridinecarboxylic acid moiety. Examples of pyridinecarboxylic acid herbicides include 4-amino-3-chloro-6-(4-chloro-2-fluoro-3-methoxyphenyl)-2-pyridinecarboxylic acid, aminopyralid, clopyralid, fluroxypyr, picloram and triclopyr. Picloram can also be in the form of a salt (e.g., potassium). Triclopyr can also be in the form of its esters (e.g., butotyl) or salts (e.g., triethylammonium).

Pyrimidinecarboxylic acid herbicide molecules include a pyrimidinecarboxylic acid moiety. Examples of pyrimidinecarboxylic acid herbicides include aminocyclopyrachlor. Aminocyclopyrachlor can be also in the form of its esters (e.g., methyl, ethyl) or salts (e.g., sodium, potassium). Of note is aminocyclopyrachlor in the form of its potassium salt (i.e. amino cyclopyrachlor-potassium).

Phenoxycarboxylic acid herbicide molecules comprise a phenoxyacetic acid moiety. Examples of phenoxycarboxylic acid herbicides include clomeprop, 2,4-D, 2,4-DB, dichlorprop, MCPA, MCPB and mecoprop. 2,4-D can also be in the form of its esters (e.g., butotyl, butyl, isoctyl or isopropyl) or its salts (e.g., dimethylammonium, diolamine or trolamine). 2,4-DB can also be in the form of its salts (e.g., dimethylammonium, potassium or sodium). MCPA can also be in the form of its salts (e.g., dimethylammonium, potassium or sodium), esters (e.g., 2-ethylhexyl or butotyl) or thioesters (e.g., thioethyl). MCPB can also be in the form of its salts (e.g., sodium) or esters (e.g., ethyl). Mecoprop can also be in its enantiomerically resolved form (e.g., mecoprop-P).

Quinolinecarboxylic acid herbicide molecules comprise a quinolinecarboxylic acid moiety. Examples of quinolinecarboxylic acid herbicides include quinclorac and quinmerac.

Benzothiazolylacetic acid herbicide molecules comprise a benzothiazolylacetic acid moiety (which can be in the form of an ester or salt). Examples of benzothiazolylacetic acid herbicides include benazolin and its ethyl ester, benazolin-ethyl.

“4-Hydroxyphenyl-pyruvate dioxygenase inhibitors” (b3) are chemical substances that inhibit the biosynthesis of 4-hydroxyphenyl-pyruvate-dioxygenase (HPPD). Herbicides inhibiting the biosynthesis of HPPD can be categorized into three chemical subclasses based on general molecular structure: triketones, pyrazoles and isoxazoles. Each of these chemical subclasses is well known in the art.

Triketone herbicide molecules comprise a triketone moiety (i.e. —C(O)—CH(—C(O)—)—C(O)—), which is typically in an enol tautomeric form that can be deprotonated (e.g., by bases) or in the form of an enol ester with an alcohol or thiol. Examples of triketone herbicides include benzobicyclon, bicyclopyrone, mesotrione, sulcotrione, tefuryltrione and tembotrione.

Pyrazole herbicide molecules comprise a pyrazole ring. Examples of pyrazole herbicides include benzofenap, pyrasulfotole, pyrazolynate, pyrazoxyfen and topramezone.

Isoxazole herbicide molecules comprise an isoxazole ring. Examples of isoxazole herbicides include isoxachlortole and isoxaflutole.

Table 1 lists specific combinations of N-(aminocarbonyl)-2-methylbenzene-sulfonamide (i.e. Compound 1) representative of component (a) with component (b) illustrative of the combinations, mixtures, compositions and methods of the present invention. The first column of Table 1 lists the specific component (b) compound (e.g., “2,4-D” in the first line). The second, third and fourth columns of Table 1 lists ranges of weight ratios for rates at which the Component (b) compound is typically applied to a field-grown crop relative to component (a). Thus, for example, the first line of Table 1 specifically discloses the combination of component (a) with 2,4-D is typically applied in a weight ratio between 1:10 to 1000:1 of 2,4-D relative to Compound 1. The remaining lines of Table 1 are to be construed similarly.

TABLE 1

| | Weight Ratios of Component (b) to Component (a) (Compound 1) | | | | | |
|---|---|---|---|---|---|---|
| | Ranges of Ratios | | | | | |
| | | More | | | | |
| Component (b) | Typical | Typical | Most Typical | Illustrative Ratios | | |
| 2,4-D | 1:10 to 1000:1 | 1:2 to 100:1 | 2:1 to 35:1 | 2:1 | 8:1 | 35:1 |
| 2,4-DB | 1:200 to 1000:1 | 1:30 to 100:1 | 1:1 to 40:1 | 1:1 | 6:1 | 40:1 |
| 4-amino-3-chloro- | 1:200 to 1000:1 | 1:30 to 100:1 | 1:1 to 40:1 | 1:1 | 6:1 | 40:1 |
| 6-(4-chloro-2-fluoro- | | | | | | |
| 3-methoxyphenyl)- | | | | | | |
| 2-pyridinecarboxylic | | | | | | |
| acid | | | | | | |
| Amidosulfuron | 1:200 to 200:1 | 1:20 to 20:1 | 1:5 to 5:1 | 1:5 | 1:1 | 5:1 |
| Aminocyclopyrachlor | 1:200 to 200:1 | 1:20 to 20:1 | 1:5 to 10:1 | 1:5 | 2:1 | 10:1 |
| Aminopyralid | 1:200 to 200:1 | 1:20 to 20:1 | 1:5 to 10:1 | 1:5 | 2:1 | 10:1 |
| Azimsulfuron | 1:200 to 200:1 | 1:50 to 20:1 | 1:10 to 10:1 | 1:10 | 1:1 | 10:1 |
| Benazolin-ethyl | 1:10 to 1000:1 | 1:2 to 100:1 | 1:2 to 35:1 | 1:2 | 4:1 | 35:1 |
| Bensulfuron-methyl | 1:200 to 200:1 | 1:50 to 20:1 | 1:10 to 10:1 | 1:10 | 1:1 | 10:1 |
| Benzobicyclon | 1:200 to 1000:1 | 1:30 to 100:1 | 1:1 to 40:1 | 1:1 | 6:1 | 40:1 |
| Benzofenap | 1:10 to 1000:1 | 1:2 to 100:1 | 2:1 to 35:1 | 2:1 | 8:1 | 35:1 |
| Bicyclopyrone | 1:10 to 1000:1 | 1:2 to 100:1 | 2:1 to 35:1 | 2:1 | 8:1 | 35:1 |
| Bispyribac-sodium | 1:200 to 200:1 | 1:50 to 20:1 | 1:10 to 10:1 | 1:10 | 1:1 | 10:1 |
| Chloramben | 1:10 to 1000:1 | 1:2 to 100:1 | 2:1 to 35:1 | 2:1 | 8:1 | 35:1 |
| Chlorimuron-ethyl | 1:200 to 200:1 | 1:50 to 20:1 | 1:10 to 10:1 | 1:10 | 1:1 | 10:1 |
| Chlorsulfuron | 1:200 to 200:1 | 1:50 to 20:1 | 1:10 to 10:1 | 1:10 | 1:1 | 10:1 |
| Cinosulfuron | 1:200 to 200:1 | 1:50 to 20:1 | 1:10 to 10:1 | 1:10 | 1:1 | 10:1 |
| Clomeprop | 1:10 to 1000:1 | 1:2 to 100:1 | 2:1 to 35:1 | 2:1 | 8:1 | 35:1 |
| Clopyralid | 1:100 to 1000:1 | 1:5 to 200:1 | 1:5 to 50:1 | 1:5 | 3:1 | 50:1 |
| Cloransulam-methyl | 1:200 to 200:1 | 1:50 to 20:1 | 1:10 to 10:1 | 1:10 | 1:1 | 10:1 |
| Cyclosulfamuron | 1:200 to 200:1 | 1:50 to 20:1 | 1:10 to 10:1 | 1:10 | 1:1 | 10:1 |
| Dicamba | 1:100 to 1000:1 | 1:5 to 200:1 | 1:5 to 50:1 | 1:5 | 3:1 | 50:1 |
| Dichlorprop | 1:10 to 1000:1 | 1:2 to 100:1 | 2:1 to 35:1 | 2:1 | 8:1 | 35:1 |
| Diclosulam | 1:200 to 200:1 | 1:50 to 20:1 | 1:10 to 10:1 | 1:10 | 1:1 | 10:1 |
| Ethametsulfuron-methyl | 1:200 to 200:1 | 1:50 to 20:1 | 1:10 to 10:1 | 1:10 | 1:1 | 10:1 |
| Ethoxysulfuron | 1:200 to 200:1 | 1:50 to 20:1 | 1:10 to 10:1 | 1:10 | 1:1 | 10:1 |
| Flazasulfuron | 1:200 to 200:1 | 1:50 to 20:1 | 1:10 to 10:1 | 1:10 | 1:1 | 10:1 |
| Florasulam | 1:200 to 200:1 | 1:50 to 20:1 | 1:10 to 10:1 | 1:10 | 1:1 | 10:1 |
| Flucarbazone | 1:200 to 200:1 | 1:50 to 20:1 | 1:10 to 10:1 | 1:10 | 1:1 | 10:1 |
| Flucetosulfuron | 1:200 to 200:1 | 1:50 to 20:1 | 1:10 to 10:1 | 1:10 | 1:1 | 10:1 |
| Flumetsulam | 1:200 to 200:1 | 1:50 to 20:1 | 1:10 to 10:1 | 1:10 | 1:1 | 10:1 |
| Flupyrsulfuron-methyl | 1:200 to 200:1 | 1:50 to 20:1 | 1:10 to 10:1 | 1:10 | 1:1 | 10:1 |
| Fluroxypyr | 1:200 to 200:1 | 1:50 to 20:1 | 1:10 to 10:1 | 1:10 | 1:1 | 10:1 |
| Foramsulfuron | 1:200 to 200:1 | 1:50 to 20:1 | 1:10 to 10:1 | 1:10 | 1:1 | 10:1 |
| Halosulfuron-methyl | 1:200 to 200:1 | 1:50 to 20:1 | 1:10 to 10:1 | 1:10 | 1:1 | 10:1 |
| Imazamox | 1:200 to 200:1 | 1:50 to 20:1 | 1:10 to 10:1 | 1:10 | 1:1 | 10:1 |
| Imazapic | 1:100 to 1000:1 | 1:5 to 200:1 | 1:5 to 50:1 | 1:5 | 3:1 | 50:1 |
| Imazapyr | 1:100 to 1000:1 | 1:5 to 200:1 | 1:5 to 50:1 | 1:5 | 3:1 | 50:1 |
| Imazaquin | 1:100 to 1000:1 | 1:5 to 200:1 | 1:5 to 50:1 | 1:5 | 3:1 | 50:1 |
| Imazethapyr | 1:200 to 200:1 | 1:50 to 20:1 | 1:10 to 10:1 | 1:10 | 1:1 | 10:1 |
| Imazamethabenz-methyl | 1:200 to 200:1 | 1:50 to 20:1 | 1:10 to 10:1 | 1:10 | 1:1 | 10:1 |
| Imazosulfuron | 1:200 to 200:1 | 1:50 to 20:1 | 1:10 to 10:1 | 1:10 | 1:1 | 10:1 |
| Iodosulfuron-methyl | 1:200 to 200:1 | 1:50 to 20:1 | 1:10 to 10:1 | 1:10 | 1:1 | 10:1 |
| Isoxachlortole | 1:100 to 100:1 | 1:10 to 50:1 | 1:10 to 20:1 | 1:10 | 2:1 | 20:1 |
| Isoxaflutole | 1:100 to 100:1 | 1:10 to 50:1 | 1:10 to 20:1 | 1:10 | 2:1 | 20:1 |
| MCPA | 1:10 to 1000:1 | 1:2 to 100:1 | 2:1 to 35:1 | 2:1 | 8:1 | 35:1 |
| MCPB | 1:10 to 1000:1 | 1:2 to 100:1 | 2:1 to 35:1 | 2:1 | 8:1 | 35:1 |
| Mecoprop | 1:10 to 1000:1 | 1:2 to 100:1 | 2:1 to 35:1 | 2:1 | 8:1 | 35:1 |
| Mesosulfuron-methyl | 1:200 to 200:1 | 1:50 to 20:1 | 1:10 to 10:1 | 1:10 | 1:1 | 10:1 |
| Mesotrione | 1:100 to 100:1 | 1:10 to 50:1 | 1:10 to 20:1 | 1:10 | 2:1 | 20:1 |
| Metazosulfuron | 1:200 to 200:1 | 1:50 to 20:1 | 1:10 to 10:1 | 1:10 | 1:1 | 10:1 |
| Metosulam | 1:200 to 200:1 | 1:50 to 20:1 | 1:10 to 10:1 | 1:10 | 1:1 | 10:1 |
| Metsulfuron-methyl | 1:200 to 200:1 | 1:50 to 20:1 | l:10 to 10:1 | 1:10 | 1:1 | 10:1 |
| Nicosulfuron | 1:200 to 200:1 | 1:50 to 20:1 | 1:10 to 10:1 | 1:10 | 1:1 | 10:1 |
| Orthosulfamuron | 1:200 to 200:1 | 1:50 to 20:1 | 1:10 to 10:1 | 1:10 | 1:1 | 10:1 |
| Oxasulfuron | 1:200 to 200:1 | 1:50 to 20:1 | 1:10 to 10:1 | 1:10 | 1:1 | 10:1 |
| Penoxsulam | 1:200 to 200:1 | 1:50 to 20:1 | 1:10 to 10:1 | 1:10 | 1:1 | 10:1 |
| Picloram | 1:200 to 500:1 | 1:10 to 200:1 | 1:5 to 100:1 | 1:5 | 4:1 | 100:1 |
| Primisulfuron-methyl | 1:200 to 200:1 | 1:50 to 20:1 | 1:10 to 10:1 | 1:10 | 1:1 | 10:1 |
| Propoxycarbazone | 1:200 to 200:1 | 1:50 to 20:1 | 1:10 to 10:1 | 1:10 | 1:1 | 10:1 |
| Propyrisulfuron | 1:200 to 200:1 | 1:50 to 20:1 | 1:10 to 10:1 | 1:20 | 1:2 | 10:1 |
| Prosulfuron | 1:200 to 200:1 | 1:50 to 20:1 | 1:10 to 10:1 | 1:10 | 1:1 | 10:1 |
| Pyrasulfotole | 1:100 to 100:1 | 1:10 to 50:1 | 1:10 to 20:1 | 1:10 | 2:1 | 20:1 |
| Pyrazolynate | 1:100 to 100:1 | 1:10 to 50:1 | 1:10 to 20:1 | 1:10 | 2:1 | 20:1 |
| Pyrazosulfuron-ethyl | 1:200 to 200:1 | 1:50 to 20:1 | 1:10 to 10:1 | 1:10 | 1:1 | 10:1 |
| Pyrazoxyfen | 1:5 to 1000:1 | 1:2 to 100:1 | 1:1 to 100:1 | 1:1 | 10:1 | 100:1 |
| Pyribenzoxim | 1:200 to 200:1 | 1:50 to 20:1 | 1:10 to 10:1 | 1:10 | 1:1 | 10:1 |
| Pyriftalid | 1:200 to 200:1 | 1:50 to 20:1 | 1:10 to 10:1 | 1:10 | 1:1 | 10:1 |
| Pyriminobac-methyl | 1:200 to 200:1 | 1:50 to 20:1 | 1:10 to 10:1 | 1:10 | 1:1 | 10:1 |
| Pyrithiobac | 1:200 to 200:1 | 1:50 to 20:1 | 1:10 to 10:1 | 1:10 | 1:1 | 10:1 |
| Pyroxsulam | 1:200 to 200:1 | 1:50 to 20:1 | 1:10 to 10:1 | 1:10 | 1:1 | 10:1 |
| Quinclorac | 1:10 to 1000:1 | 2:1 to 100:1 | 2:1 to 35:1 | 2:1 | 8:1 | 35:1 |
| Quinmerac | 1:100 to 100:1 | 1:10 to 50:1 | 1:10 to 20:1 | 1:10 | 2:1 | 20:1 |
| Rimsulfuron | 1:200 to 200:1 | 1:50 to 20:1 | 1:10 to 10:1 | 1:10 | 1:1 | 10:1 |
| Sulcotrione | 1:10 to 1000:1 | 1:2 to 100:1 | 2:1 to 35:1 | 2:1 | 8:1 | 35:1 |
| Sulfometuron-methyl | 1:200 to 200:1 | 1:50 to 20:1 | 1:10 to 10:1 | 1:10 | 1:1 | 10:1 |
| Sulfosulfuron | 1:200 to 200:1 | 1:50 to 20:1 | 1:10 to 10:1 | 1:10 | 1:1 | 10:1 |
| 2,3,6-TBA | 1:100 to 100:1 | 1:10 to 50:1 | 1:10 to 20:1 | 1:10 | 2:1 | 20:1 |
| Tefuryltrione | 1:100 to 100:1 | 1:10 to 50:1 | 1:10 to 20:1 | 1:10 | 2:1 | 20:1 |
| Tembotrione | 1:100 to 100:1 | 1:10 to 50:1 | 1:10 to 20:1 | 1:10 | 2:1 | 20:1 |
| Thiencarbazone-methyl | 1:200 to 200:1 | 1:50 to 20:1 | 1:10 to 10:1 | 1:10 | 1:1 | 10:1 |
| Thifensulfuron-methyl | 1:200 to 200:1 | 1:50 to 20:1 | 1:50 to 10:1 | 1:50 | 1:3 | 10:1 |
| Topramazone | 1:100 to 100:1 | 1:10 to 50:1 | 1:10 to 20:1 | 1:10 | 2:1 | 20:1 |
| Triasulfuron | 1:200 to 200:1 | 1:50 to 20:1 | 1:10 to 10:1 | 1:10 | 1:1 | 10:1 |
| Tribenuron-methyl | 1:200 to 200:1 | 1:50 to 20:1 | 1:10 to 10:1 | 1:10 | 1:1 | 10:1 |
| Triclopyr | 1:10 to 1000:1 | 1:2 to 100:1 | 2:1 to 35:1 | 2:1 | 8:1 | 35:1 |
| Trifloxysulfuron | 1:200 to 200:1 | 1:50 to 20:1 | 1:10 to 10:1 | 1:10 | 1:1 | 10:1 |
| Triflusulfuron-methyl | 1:200 to 200:1 | 1:50 to 20:1 | 1:10 to 10:1 | 1:10 | 1:1 | 10:1 |
| Tritosulfuron | 1:200 to 200:1 | 1:50 to 20:1 | 1:10 to 10:1 | 1:10 | 1:1 | 10:1 |

### Formulations

Component (a) (i.e. at least one compound selected from N-(aminocarbonyl)-2-methylbenzenesulfonamide and salts thereof) and component (b) (i.e. at least one herbicide compound selected from (b1) acetohydroxy acid synthase inhibitors, (b2) auxin mimics, (b3) 4-hydroxyphenyl-pyruvate dioxygenase inhibitors, and salts of compounds of (b1) through (b3) in the combinations, mixtures and methods described herein can be formulated in a number of ways:
(1) component (a) can be formulated for application directly to the propagule (e.g., seed, bulb, tuber or rhizome) of a crop;
(2) components (a) and (b) can be formulated separately and applied separately or applied simultaneously (i.e. to the locus of a crop) in an appropriate weight ratio, e.g., as a tank mix; or
(3) components (a) and (b) can be formulated together in the proper weight ratio (and then applied to the locus of a crop).

Formulation involves forming a composition comprising component (a) and/or (b) and at least one additional component selected from the group consisting of surfactants, solid diluents and liquid diluents, which serves as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspo-emulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including coatings of propagules such as seeds) and the like, which can be water-dispersible (“wettable”) or water-soluble. Films and coatings formed from film-forming solutions or flowable suspensions are particularly useful for propagule treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto propagules (e.g., seeds) of crops and other desirable vegetation as seed treatments before planting to protect developing roots and other subterranean plant parts and/or foliage through systemic uptake.

The formulations will typically contain effective amounts of active ingredient (e.g., components (a) and/or (b)), diluent and surfactant within the following approximate ranges which add up to 100 percent by weight.

| | Weight Percent | | |
|---|---|---|---|
| | Active | | |
| | Ingredient | Diluent | Surfactant |
| Water-Dispersible and Water- | 0.001-90 | 0-99.999 | 0-15 |
| soluble Granules, Tablets and | | | |
| Powders | | | |
| Oil Dispersions, Suspensions, | 1-50 | 40-99 | 0-50 |
| Emulsions, Solutions | | | |
| (including Emulsifiable | | | |
| Concentrates) | | | |
| Dusts | 1-25 | 70-99 | 0-5 |
| Granules and Pellets | 0.001-99 | 5-99.999 | 0-15 |
| High Strength Compositions | 90-99 | 0-10 | 0-2 |

Solid diluents include, for example, clays such as bentonite, montmorillonite, attapulgite and kaolin, gypsum, cellulose, titanium dioxide, zinc oxide, starch, dextrin, sugars (e.g., lactose, sucrose), silica, talc, mica, diatomaceous earth, urea, calcium carbonate, sodium carbonate and bicarbonate, and sodium sulfate. Typical solid diluents are described in Watkins et al., Handbook of Insecticide Dust Diluents and Carriers, 2nd Ed., Dorland Books, Caldwell, N.J.

Liquid diluents include, for example, water, N,N-dimethylalkanamides (e.g., N,N-dimethylformamide), limonene, dimethyl sulfoxide, N-alkylpyrrolidones (e.g., N-methylpyrrolidinone), ethylene glycol, triethylene glycol, propylene glycol, dipropylene glycol, polypropylene glycol, propylene carbonate, butylene carbonate, paraffins (e.g., white mineral oils, normal paraffins, isoparaffins), alkylbenzenes, alkylnaphthalenes, glycerine, glycerol triacetate, sorbitol, aromatic hydrocarbons, dearomatized aliphatics, alkylbenzenes, alkylnaphthalenes, ketones such as cyclohexanone, 2-heptanone, isophorone and 4-hydroxy-4-methyl-2-pentanone, acetates such as isoamyl acetate, hexyl acetate, heptyl acetate, octyl acetate, nonyl acetate, tridecyl acetate and isobornyl acetate, other esters such as alkylated lactate esters, dibasic esters and y-butyrolactone, and alcohols, which can be linear, branched, saturated or unsaturated, such as methanol, ethanol, n-propanol, isopropyl alcohol, n-butanol, isobutyl alcohol, n-hexanol, 2-ethylhexanol, n-octanol, decanol, isodecyl alcohol, isooctadecanol, cetyl alcohol, lauryl alcohol, tridecyl alcohol, oleyl alcohol, cyclohexanol, tetrahydrofurfuryl alcohol, diacetone alcohol and benzyl alcohol. Liquid diluents also include glycerol esters of saturated and unsaturated fatty acids (typically C₆-C₂₂), such as plant seed and fruit oils (e.g., oils of olive, castor, linseed, sesame, corn (maize), peanut, sunflower, grapeseed, safflower, cottonseed, soybean, rapeseed, coconut and palm kernel), animal-sourced fats (e.g., beef tallow, pork tallow, lard, cod liver oil, fish oil), and mixtures thereof. Liquid diluents also include alkylated fatty acids (e.g., methylated, ethylated, butylated) wherein the fatty acids may be obtained by hydrolysis of glycerol esters from plant and animal sources, and can be purified by distillation. Typical liquid diluents are described in Marsden, Solvents Guide, 2nd Ed., Interscience, New York, 1950.

The solid and liquid compositions of the present invention often include one or more surfactants. When added to a liquid, surfactants (also known as “surface-active agents”) generally modify, most often reduce, the surface tension of the liquid. Depending on the nature of the hydrophilic and lipophilic groups in a surfactant molecule, surfactants can be useful as wetting agents, dispersants, emulsifiers or defoaming agents.

Surfactants can be classified as nonionic, anionic or cationic. Nonionic surfactants useful for the present compositions include, but are not limited to: alcohol alkoxylates such as alcohol alkoxylates based on natural and synthetic alcohols (which may be branched or linear) and prepared from the alcohols and ethylene oxide, propylene oxide, butylene oxide or mixtures thereof; amine ethoxylates, alkanolamides and ethoxylated alkanolamides; alkoxylated triglycerides such as ethoxylated soybean, castor and rapeseed oils; alkylphenol alkoxylates such as octylphenol ethoxylates, nonylphenol ethoxylates, dinonyl phenol ethoxylates and dodecyl phenol ethoxylates (prepared from the phenols and ethylene oxide, propylene oxide, butylene oxide or mixtures thereof); block polymers prepared from ethylene oxide or propylene oxide and reverse block polymers where the terminal blocks are prepared from propylene oxide; ethoxylated fatty acids; ethoxylated fatty esters and oils; ethoxylated methyl esters; ethoxylated tristyrylphenol (including those prepared from ethylene oxide, propylene oxide, butylene oxide or mixtures thereof); fatty acid esters, glycerol esters, lanolin-based derivatives, polyethoxylate esters such as polyethoxylated sorbitan fatty acid esters, polyethoxylated sorbitol fatty acid esters and polyethoxylated glycerol fatty acid esters; other sorbitan derivatives such as sorbitan esters; polymeric surfactants such as random copolymers, block copolymers, alkyd peg (polyethylene glycol) resins, graft or comb polymers and star polymers; polyethylene glycols (pegs); polyethylene glycol fatty acid esters; silicone-based surfactants; and sugar-derivatives such as sucrose esters, alkyl polyglycosides and alkyl polysaccharides.

Useful anionic surfactants include, but are not limited to: alkylaryl sulfonic acids and their salts; carboxylated alcohol or alkylphenol ethoxylates; diphenyl sulfonate derivatives; lignin and lignin derivatives such as lignosulfonates; maleic or succinic acids or their anhydrides; olefin sulfonates; phosphate esters such as phosphate esters of alcohol alkoxylates, phosphate esters of alkylphenol alkoxylates and phosphate esters of styryl phenol ethoxylates; protein-based surfactants; sarcosine derivatives; styryl phenol ether sulfate; sulfates and sulfonates of oils and fatty acids; sulfates and sulfonates of ethoxylated alkylphenols; sulfates of alcohols; sulfates of ethoxylated alcohols; sulfonates of amines and amides such as N,N-alkyltaurates; sulfonates of benzene, cumene, toluene, xylene, and dodecyl and tridecylbenzenes; sulfonates of condensed naphthalenes; sulfonates of naphthalene and alkyl naphthalene; sulfonates of fractionated petroleum; sulfosuccinamates; and sulfosuccinates and their derivatives such as dialkyl sulfosuccinate salts.

Useful cationic surfactants include, but are not limited to: amides and ethoxylated amides; amines such as N-alkyl propanediamines, tripropylenetriamines and dipropylenetetramines, and ethoxylated amines, ethoxylated diamines and propoxylated amines (prepared from the amines and ethylene oxide, propylene oxide, butylene oxide or mixtures thereof); amine salts such as amine acetates and diamine salts; quaternary ammonium salts such as quaternary salts, ethoxylated quaternary salts and diquaternary salts; and amine oxides such as alkyldimethylamine oxides and bis-(2-hydroxyethyl)-alkylamine oxides.

Also useful for the present compositions are mixtures of nonionic and anionic surfactants or mixtures of nonionic and cationic surfactants. Nonionic, anionic and cationic surfactants and their recommended uses are disclosed in a variety of published references including McCutcheon's Emulsifiers and Detergents, annual American and International Editions published by McCutcheon's Division, The Manufacturing Confectioner Publishing Co.; Sisely and Wood, Encyclopedia of Surface Active Agents, Chemical Publ. Co., Inc., New York, 1964; and A. S. Davidson and B. Milwidsky, Synthetic Detergents, Seventh Edition, John Wiley and Sons, New York, 1987.

Compositions of this invention may also contain formulation auxiliaries and additives, known to those skilled in the art as formulation aids (some of which may be considered to also function as solid diluents, liquid diluents or surfactants). Such formulation auxiliaries and additives may control: pH (buffers), foaming during processing (antifoams such polyorganosiloxanes), sedimentation of active ingredients (suspending agents), viscosity (thixotropic thickeners), in-container microbial growth (antimicrobials), product freezing (antifreezes), color (dyes/pigment dispersions), wash-off (film formers or adhesive agents), evaporation (evaporation retardants), and other formulation attributes.

Coatings of propagules such as seeds typically comprise at least one film former or adhesive agent in addition to at least one compound selected from N-(aminocarbonyl)-2-methylbenzenesulfonamide and salts thereof. The film former or adhesive agent component of the propagule coating is composed preferably of an adhesive polymer that can be natural or synthetic and is without phytotoxic effect on the propagule to be coated. The film former or sticking agent can be selected from polyvinyl acetates, polyvinyl acetate copolymers, hydrolyzed polyvinyl acetates, polyvinylpyrrolidone-vinyl acetate copolymer, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxy-methylcelluloses, hydroxypropylcellulose, hydroxymethylpropylcelluloses, polyvinyl-pyrrolidones, alginates, dextrins, malto-dextins, polysaccharides, fats, oils, proteins, karaya gum, guar gum, tragacanth gum, polysaccharide gums, mucilage, gum arabics, shellacs, vinylidene chloride polymers and copolymers, soybean-based protein polymers and copolymers, lignosulfonates, acrylic copolymers, starches, polyvinylacrylates, zeins, gelatin, carboxymethylcellulose, chitosan, polyethylene oxide, ethylene oxide-propylene oxide block copolymers, acrylimide polymers and copolymers, polyhydroxyethyl acrylate, methylacrylimide monomers, alginate, ethylcellulose, polychloroprene and syrups or mixtures thereof. Of note are polyvinylpyrrolidone-vinyl acetate copolymers and water-soluble waxes. The amount of film former or adhesive agent in the composition applied to a propagule is generally in the range of about 0.001 to 100% of the weight of the propagule. For large seeds the amount of film former or adhesive agent is typically in the range of about 0.05 to 5% of the seed weight; for small seeds the amount is typically in the range of about 1 to 100%, but can be greater than 100% of seed weight in pelleting. For other propagules the amount of film former or adhesive agent is typically in the range of 0.001 to 2% of the propagule weight.

Examples of formulation auxiliaries and additives include those listed in McCutcheon's Volume 2: Functional Materials, annual International and North American editions published by McCutcheon's Division, The Manufacturing Confectioner Publishing Co.; and PCT Publication WO 03/024222.

Active ingredients (e.g., components (a) and/or (b)) are typically incorporated into the present compositions by dissolving the active ingredient in a solvent or by grinding in a liquid or dry diluent. Solutions, including emulsifiable concentrates, can be prepared by simply mixing the ingredients. If the solvent of a liquid composition intended for use as an emulsifiable concentrate is water-immiscible, an emulsifier is typically added to emulsify the active-containing solvent upon dilution with water. Active ingredient slurries, with particle diameters of up to 2,000 μm can be wet milled using media mills to obtain particles with average diameters below 3 μm. Aqueous slurries can be made into finished suspension concentrates (see, for example, U.S. Pat. No. 3,060,084) or further processed by spray drying to form water-dispersible granules. Dry formulations usually require dry milling processes, which produce average particle diameters in the 2 to 10 μm range. Dusts and powders can be prepared by blending and usually grinding (such as with a hammer mill or fluid-energy mill). Granules and pellets can be prepared by spraying the active material upon preformed granular carriers or by agglomeration techniques. See Browning, “Agglomeration”, Chemical Engineering, Dec. 4, 1967, pp 147-48, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; Hance et al., Weed Control Handbook, 8th Ed., Blackwell Scientific Publications, Oxford, 1989; and Developments in formulation technology, PJB Publications, Richmond, UK, 2000.

In the following Examples, all percentages are by weight and all formulations are prepared in conventional ways. Compound 1 refers to the compound of Formula 1. Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except where otherwise indicated.

### EXAMPLE A

High Strength Concentrate

| | |
|---|---|
| Compound 1 | 65.7% |
| sulfometuron-methyl | 32.8% |
| silica aerogel | 0.5% |
| synthetic amorphous fine silica | 1.0% |

### EXAMPLE B

Wettable Powder

| | |
|---|---|
| Compound 1 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0% |

### EXAMPLE C

Granule

| | |
|---|---|
| Compound 1 | 6.7% |
| rimsulfuron | 3.3% |
| attapulgite granules (low volatile matter, 0.71/0.30 mm; | 90.0% |
| U.S.S. No. 25-50 sieves) | |

### EXAMPLE D

Extruded Pellet

| | |
|---|---|
| Compound 1 | 16.7% |
| flupyrsulfuron-methyl | 8.3% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### EXAMPLE E

Emulsifiable Concentrate

| | |
|---|---|
| Compound 1 | 9.0% |
| 2,4-D-2-ethylhexyl | 1.0% |
| polyoxyethylene sorbitol hexoleate | 20.0% |
| C₆-C₁₀ fatty acid methyl ester | 70.0% |

### EXAMPLE F

Microemulsion

| | |
|---|---|
| Compound 1 | 3.0% |
| mesotrione | 2.0% |
| polyvinylpyrrolidone-vinyl acetate copolymer | 30.0% |
| alkylpolyglycoside | 30.0% |
| glyceryl monooleate | 15.0% |
| water | 20.0% |

### EXAMPLE G

Granule

| | |
|---|---|
| Compound 1 | 6.7% |
| aminocyclopyrachlor, potassium salt | 3.3% |
| attapulgite granules (low volatile matter, 0.71/0.30 mm; | 90.0% |
| U.S.S. No. 25-50 sieves) | |

### EXAMPLE H

Extruded Pellet

| | |
|---|---|
| Compound 1 | 4.4% |
| rimsulfuron | 2.2% |
| dicamba, sodium salt | 18.4% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0% |

### EXAMPLE I

Emulsifiable Concentrate

| | |
|---|---|
| Compound 1 | 1.0% |
| 2,4-D-2-ethylhexyl | 9.0% |
| polyoxyethylene sorbitol hexoleate | 20.0% |
| C₆-C₁₀ fatty acid methyl ester | 70.0% |

### EXAMPLE J

Seed Treatment

| | |
|---|---|
| Compound 1 | 20.00% |
| polyvinylpyrrolidone-vinyl acetate copolymer | 5.00% |
| montan acid wax | 5.00% |
| calcium ligninsulfonate | 1.00% |
| polyoxyethylene/polyoxypropylene block copolymers | 1.00% |
| stearyl alcohol (POE 20) | 2.00% |
| polyorganosilane | 0.20% |
| colorant red dye | 0.05% |
| water | 65.75% |

As already mentioned, N-(aminocarbonyl)-2-methylbenzenesulfonamide (Formula 1, also identified as Compound 1) and salts thereof (i.e. component (a)) have been discovered to be extraordinarily effective in safening herbicides of the (b1) acetohydroxy acid synthase inhibitor, (b2) auxin mimic, and (b3) 4-hydroxyphenyl-pyruvate dioxygenase inhibitor classes of herbicides on a wide variety of crops while retaining efficacy of the herbicides in controlling agronomically important weeds. Accordingly, mixtures of component (a) (i.e. Formula 1 or a salt thereof) with herbicides of these herbicide classes are useful for protecting crop plants from injury caused by the herbicides while allowing the herbicides to provide effective weed control. Therefore combination of safener component (a) with herbicide component (b) can increase the selectivity of control of undesired vegetation in a crop (i.e. improved weed control selectivity). Component (a) can eliminate, or reduce to an acceptable level, phytotoxic responses to herbicides in the (b1) acetohydroxy acid synthase inhibitor, (b2) auxin mimic, and (b3) 4-hydroxyphenyl-pyruvate dioxygenase inhibitor classes in crops such as alfalfa, barley, cotton, wheat, rape, sugar beets, maize (corn), sorghum, soybeans, sunflower, rice, oats, peanuts, vegetables, tomato, potato, perennial plantation crops including coffee, cocoa, oil palm, rubber, sugarcane, citrus, grapes, fruit trees, nut trees, banana, plantain, pineapple, hops, tea and forests such as eucalyptus and conifers (e.g., loblolly pine), pasture grasses (e.g., Brachiaria spp. such as B. decumbens Stapf., B. brizantha Hochst. ex A. Rich and B. plantaginea (Link) A. S. Hitchc.) and turf grasses (e.g., Poa pratensis L., Stenotaphrum secundatum (Walt.) Kuntze, Festuca spp. including Festuca arundinacea Shreib. and hard fescue, Agrostis stoonoifera L., Lolium perenne L., Kentucky fescue and Cynodon dactylon (L.) Pers., Zoysia japonica Steud.). Of particular note are the grass crops wheat, barley, maize, sorghum, sugarcane, pasture grasses and turf grasses, and the broadleaf crops sunflower and soybeans, illustrated in Tests A-K below.

Remarkably, component (a) improves the herbicide tolerance of crop varieties that in the absence of component (a) only slowly metabolize, and thus are particularly sensitive to, the (b1) acetohydroxy acid synthase inhibitor, (b2) auxin mimic, and/or (b3) 4-hydroxyphenyl-pyruvate dioxygenase inhibitor herbicide classes. This is illustrated by Tests A, B and C below using Pioneer 39K40 hybrid maize, which is particularly sensitive to herbicides that inhibit the acetohydroxy acid synthase enzyme.

Component (a) also further improves the herbicide tolerance of crop varieties that have been genetically modified either through conventional breeding or transgenic engineering to include genes providing enhanced tolerance to herbicides such as of the (b1) acetohydroxy acid synthase inhibitor, (b2) auxin mimic, and (b3) 4-hydroxyphenyl-pyruvate dioxygenase inhibitor classes, including genes that enhance tolerance by means other than increasing herbicide metabolism. This is illustrated by Test D below using sorghum hybrids WL09-6001 and WL09-6002 incorporating resistance to acetohydroxy acid synthase-inhibiting herbicides, and by Test H using sunflower hybrid Pioneer 63N82 incorporating resistance to tribenuron-methyl.

Of note are combinations, mixtures, compositions and methods of the present invention wherein herbicide component (b) comprises at least one herbicide compound selected from (b1) acetohydroxy acid synthase inhibitors and (b2) auxin mimics. Of particular note are combinations, mixtures, compositions and methods of the present invention wherein herbicide component (b) comprises at least one herbicide compound selected from (b1) acetohydroxy acid synthase inhibitors, or more particularly, sulfonylurea herbicides.

Antidotally effective amounts and the optimal ratio of safener component (a) (i.e. Formula 1 or a salt thereof) to herbicide component (b) in the combinations, mixtures, compositions and methods of the present invention will depend upon a variety of factors, including the herbicide used, the application method, and the crop desired to be safened, and can be determined by one skilled in the art through simple experimentation. Generally, the weight ratio of component (a) to component (b) is in the range of 1:1000 to 1000:1, or 1:200 to 1000:1, typically in the range of 1:200 to 200:1, or 1:50 to 200:1, and more typically in the range of 1:100 to 100:1, 1:10 to 100:1, or 1:2 to 100:1. Most typically the weight ratio is in the range of 1:2 to 40:1, or 1:1 to 50:1, particularly when component (b) comprises one or more sulfonylurea herbicides. These ratios can also be expressed as weight ratios of herbicide component (b) to safener component (a) by interchanging the numbers surrounding the semicolon. For example, most typically the weight ratio of component (b) to component (a) is in the range of 2:1 to 1:40, or 1:1 to 1:50, particularly when component (b) comprises one or more sulfonylurea herbicides. Table 1 above lists ranges of ratios and illustrative ratios for particular herbicides of component (b) relative to component (a). Most generally, component (a) is applied in the range of 1 g/ha to 20 kg/ha. Herbicidally effective, including optimal, amounts of component (b) will also depend upon a variety of factors such as environmental conditions, and species and growth stage of undesired vegetation to be controlled. One skilled in the art can easily determine the herbicidally effective amount necessary for the desired level of weed control. Most generally, component (b) is applied in the range of 0.1 g/ha to 10 kg/ha. Typical application rates for commercial herbicides, such as those listed in Table 1, are well known to those skilled in the art, and are published in such references as The Pesticide Manual, Fifteenth Edition, C. D. S. Tomlin editor, British Crop Protection Council, UK, 2009.

A variety of methods are available for combining the application of safener component (a) and herbicide component (b) to the locus of crop plants. Component (a) can be applied directly to a propagule of the crop (e.g., seed of maize, sorghum, wheat, barley, soybean or sunflower) before planting by spraying or dusting the propagule with at least one compound selected from Formula 1 and salts thereof (i.e. as a formulated composition). In the context of the present disclosure and claims, treating a propagule (e.g., seed) means contacting the propagule with an antidotally effective amount of at least one compound selected from Formula 1 and salts thereof, which is typically formulated as a composition of the invention. Propagule treatment is particularly useful for selective weed control, because it physically restricts antidoting to the crop plants. Therefore a particularly useful embodiment of the present invention is a method for selectively controlling the growth of undesired vegetation in a crop comprising treating a propagule, especially a seed, of a crop with an antidotally effective amount of safener component (a) followed by applying a herbicidally effective amount of herbicide component (b) to the locus of the crop plant grown from the propagule (e.g., postemergence application).

Compositions formulated for treatment of propagules, particularly seeds, generally comprise a film former or adhesive agent. Therefore typically a propagule coating composition of the present invention comprises at least one compound selected from Formula 1 and salts thereof (i.e. in an antidotally effective amount), and a film former or adhesive agent. Seed can be coated by spraying a flowable suspension concentrate directly into a tumbling bed of seeds and then drying the seeds. Alternatively, other formulation types such as wetted powders, solutions, suspoemulsions, emulsifiable concentrates and emulsions in water can be sprayed on the seed. This process is particularly useful for applying film coatings on seeds. Various coating machines and processes are available to one skilled in the art. Suitable processes include those listed in P. Kosters et al., Seed Treatment: Progress and Prospects, 1994 BCPC Monograph No. 57, and references listed therein.

Alternatively, component (a) (e.g., in a formulated composition) can be applied over exposed seed in open furrows at planting, just prior to covering the seed with soil (i.e. in-furrow treatment). Herbicide component (b) (e.g., in a formulated composition) can then be applied either preemergence or postemergence to the crop and/or weeds.

Antidotally effective amounts, including optimal amounts, of component (a) applied to propagules can be easily determined by one skilled in the art through simple experimentation. Typically when component (a) is applied as a seed coating, it is applied in an amount of typically about 0.01 to 1%, more typically about 0.1 to 0.5% of the seed weight. When such coated seeds are planted at a rate of 10 to 150 kg/ha, the component (a) antidote is distributed in the locus of the crop in the amount of typically about 0.001 to 1.5 kg/ha, more typically about 0.01 to 0.75 kg/ha.

In a method not requiring seed treatment, an antidotally effective amount of component (a) is combined with herbicide component (b) to form a mixture or composition, which is applied either preemergence or postemergence to the crop and/or weeds. In an embodiment of this method, N-(aminocarbonyl)-2-methylbenzenesulfonamide (Compound 1) is combined with flupyrsulfuron-methyl in a weight ratio in the range of 1:2 to 10:1 of Compound 1 relative to flupyrsulfuron-methyl and applied preemergence or postemergence to a wheat or barley crop for preemergence or postemergence control of blackgrass and certain broadleaf weeds. In an another embodiment, Compound 1 is combined with rimsulfuron in a weight ratio in the range of 1:2 to 10:1 of Compound 1 relative to rimsulfuron and applied postemergence to a maize crop to control weeds already emerged (postemergence to the grass and broadleaf weeds) or weeds that have yet to emerge (preemergence to the grass and broadleaf weeds). In another embodiment, Compound 1 is combined with thifensulfuron-methyl in a weight ratio in the range of 5:1 to 40:1 of Compound 1 relative to thifensulfuron-methyl and applied postemergence to a soybean crop to allow the thifensulfuron-methyl to selectively control broadleaf weeds with reduced phytotoxic response by the soybean crop. In another embodiment, Compound 1 is combined with rimsulfuron in a weight ratio in the range of 1:2 to 10:1 of Compound 1 relative to rimsulfuron to reduce the crop phytotoxic response when applied to a sorghum crop that has been genetically modified to contain a gene for improved tolerance to sulfonylurea herbicides. In another embodiment, Compound 1 is combined with sulfometuron-methyl in a weight ratio in the range of 1:2 to 10:1 of Compound 1 relative to sulfometuron-methyl to reduce the crop phytotoxic response when applied to a sunflower crop that has been genetically modified to contain a gene for improved tolerance to the sulfonylurea herbicide tribenuron-methyl.

Combinations, mixtures and compositions comprising components (a) and/or (b) according to the present invention can be further mixed with one or more other biologically active compounds or agents including herbicides, herbicide safeners, fungicides, insecticides, nematocides, bactericides, acaricides, growth regulators such as insect molting inhibitors and rooting stimulants, chemosterilants, semiochemicals, repellents, attractants, pheromones, feeding stimulants, plant nutrients, other biologically active compounds or entomopathogenic bacteria, virus or fungi to form a multi-component pesticide giving an even broader spectrum of agricultural protection. Mixtures of the combinations, mixtures and compositions of the invention with other herbicides can broaden the spectrum of activity against additional weed species, and suppress the proliferation of any resistant biotypes. Thus the present invention also pertains to a mixture or composition comprising component (a) (in an antidotally effective amount), component (b) (in a herbicidally effective amount) and at least one additional biologically active compound or agent (in a biologically effective amount) and can further comprise at least one of a surfactant, a solid diluent or a liquid diluent. The other biologically active compounds or agents can be formulated in compositions comprising at least one of a surfactant, solid or liquid diluent. For mixtures of the present invention, one or more other biologically active compounds or agents can be formulated together with components (a) and/or (b), to form a premix, or one or more other biologically active compounds or agents can be formulated separately from components (a) and/or (b), and the formulations combined together before application (e.g., in a spray tank) or, alternatively, applied in succession.

A mixture of one or more of the following herbicides with a mixture or composition comprising components (a) and/or (b) according to this invention may be particularly useful for weed control: acetochlor, acifluorfen and its sodium salt, aclonifen, acrolein (2-propenal), alachlor, alloxydim, ametryn, amicarbazone, amitrole, ammonium sulfamate, anilofos, asulam, atrazine, beflubutamid, bencarbazone, benfluralin, benfuresate, bensulide, bentazone, bifenox, bilanafos, bromacil, bromobutide, bromofenoxim, bromoxynil, bromoxynil octanoate, butachlor, butafenacil, butamifos, butralin, butroxydim, butylate, cafenstrole, carbetamide, carfentrazone-ethyl, catechin, chlomethoxyfen, chlorbromuron, chlorflurenol-methyl, chloridazon, chlorotoluron, chlorpropham, chlorthal-dimethyl, chlorthiamid, cinidon-ethyl, cinmethylin, clefoxydim, clethodim, clodinafop-propargyl, clomazone, cumyluron, cyanazine, cycloate, cycloxydim, cyhalofop-butyl, daimuron, dalapon, dalapon-sodium, dazomet, desmedipham, desmetryn, dichlobenil, diclofop-methyl, difenzoquat metilsulfate, diflufenican, diflufenzopyr, dimefuron, dimepiperate, dimethachlor, dimethametryn, dimethenamid, dimethenamid-P, dimethipin, dimethylarsinic acid and its sodium salt, dinitramine, dinoterb, diphenamid, diquat dibromide, dithiopyr, diuron, DNOC, endothal, EPTC, esprocarb, ethalfluralin, ethiozin, ethofumesate, ethoxyfen, etobenzanid, fenoxaprop-ethyl, fenoxaprop-P-ethyl, fenoxasulfone, fentrazamide, fenuron, fenuron-TCA, flamprop-methyl, flamprop-M-isopropyl, flamprop-M-methyl, fluazifop-butyl, fluazifop-P-butyl, fluazolate, fluchloralin, flufenacet, flufenpyr, flufenpyr-ethyl, flumiclorac-pentyl, flumioxazin, fluometuron, fluoroglycofen-ethyl, flupoxam, flurenol, flurenol-butyl, fluridone, flurochloridone, flurtamone, fluthiacet-methyl, fomesafen, fosamine-ammonium, glufosinate, glufosinate-ammonium, glyphosate and its salts such as ammonium, isopropylammonium, potassium, sodium (including sesquisodium) and trimesium (alternatively named sulfosate), haloxyfop-etotyl, haloxyfop-methyl, hexazinone, indanofan, ioxynil, ioxynil octanoate, ioxynil-sodium, isoproturon, isouron, isoxaben, lactofen, lenacil, linuron, maleic hydrazide, mecoprop, mefenacet, mefluidide, metam-sodium, metamifop, metamitron, metazachlor, methabenzthiazuron, methylarsonic acid and its calcium, monoammonium, monosodium and disodium salts, methyldymron, metobenzuron, metobromuron, metolachlor, S-metolachlor, metoxuron, metribuzin, molinate, monolinuron, naproanilide, napropamide, naptalam, neburon, norflurazon, orbencarb, oryzalin, oxadiargyl, oxadiazon, oxaziclomefone, oxyfluorfen, paraquat dichloride, pebulate, pelargonic acid, pendimethalin, pentanochlor, pentoxazone, perfluidone, pethoxamid, pethoxyamid, phenmedipham, picolinafen, pinoxaden, piperophos, pretilachlor, prodiamine, profoxydim, prometon, prometryn, propachlor, propanil, propaquizafop, propazine, propham, propisochlor, propyzamide, prosulfocarb, pyraclonil, pyraflufen-ethyl, pyrazogyl, pyributicarb, pyridate, pyrimisulfan, pyroxasulfone, quinoclamine, quizalofop-ethyl, quizalofop-P-ethyl, quizalofop-P-tefuryl, sethoxydim, siduron, simazine, simetryn, sulfentrazone, TCA, TCA-sodium, tebutam, tebuthiuron, tepraloxydim, terbacil, terbumeton, terbuthylazine, terbutryn, thenylchlor, thiazopyr, thiobencarb, tiocarbazil, tralkoxydim, tri-allate, triaziflam, tridiphane, trietazine, trifluralin and vernolate. Other herbicides also include bioherbicides such as Alternaria destruens Simmons, Colletotrichum gloeosporiodes (Penz.) Penz. & Sacc., Drechsiera monoceras (MTB-951), Myrothecium verrucaria (Albertini & Schweinitz) Ditmar: Fries, Phytophthora palmivora (Butl.) Butl. and Puccinia thlaspeos Schub.

Mixtures and compositions comprising components (a) and/or (b) according to this invention can also be used in combination with plant growth regulators such as aviglycine, N-(phenylmethyl)-1H-purin-6-amine, epocholeone, gibberellic acid, gibberellin A₄ and A₇, harpin protein, mepiquat chloride, prohexadione calcium, prohydrojasmon, sodium nitrophenolate and trinexapac-methyl, and plant growth modifying organisms such as Bacillus cereus strain BP01.

General references for agricultural protectants (i.e. herbicides, herbicide safeners, insecticides, fungicides, nematocides, acaricides and biological agents) include The Pesticide Manual, 13th Edition, C. D. S. Tomlin, Ed., British Crop Protection Council, Farnham, Surrey, U.K., 2003 and The BioPesticide Manual, 2nd Edition, L. G. Copping, Ed., British Crop Protection Council, Farnham, Surrey, U.K., 2001.

For embodiments where one or more of these various mixing partners are used, the weight ratio of these various mixing partners (in total) to herbicide component (b) according to the present invention is typically between about 1:3000 and about 3000:1. Of note are weight ratios between about 1:300 and about 300:1 (for example ratios between about 1:30 and about 30:1). One skilled in the art can easily determine through simple experimentation the biologically effective amounts of active ingredients necessary for the desired spectrum of biological activity. It will be evident that including these additional components may expand the spectrum of weeds controlled beyond the spectrum controlled by the herbicide component (b) alone.

In certain instances, combinations of herbicide component (b) with other biologically active (particularly herbicidal) compounds or agents (i.e. active ingredients) can result in a greater-than-additive (i.e. synergistic) effect on weeds and/or a less-than-additive effect (i.e. safening) on crops or other desirable plants in addition to the safening provided by present component (a). Reducing the quantity of active ingredients released in the environment while ensuring effective pest control is always desirable. Ability to use greater amounts of active ingredients to provide more effective weed control without excessive crop injury is also desirable. When synergism of herbicidal active ingredients occurs on weeds at application rates giving agronomically satisfactory levels of weed control, such combinations can be advantageous for reducing crop production cost and decreasing environmental load. When safening of herbicidal active ingredients occurs on crops, such combinations can be advantageous for increasing crop protection by reducing weed competition. Besides safening component (b), component (a) may also safen herbicidal compounds or agents besides component (b) on crops to further increase crop tolerance to herbicide combinations.

Of note is a combination of mixture or composition comprising components (a) and (b) according to the invention with at least one other herbicidal active ingredient. Of particular note is such a combination where the other herbicidal active ingredient has different site of action from component (b) of the invention. In certain instances, a combination with at least one other herbicidal active ingredient having a similar spectrum of control but a different site of action will be particularly advantageous for resistance management. Thus, a mixture or composition of the present invention can further comprise (in a herbicidally effective amount) at least one additional herbicidal active ingredient having a similar spectrum of control but a different site of action.

Because component (a) safens herbicide component (b) in the combinations, mixtures, compositions and methods of the present invention, an additional safener is typically not used. Nevertheless, combinations, mixtures, compositions and methods of this invention can also be used in combination with additional herbicide safeners such as allidochlor, benoxacor, BCS (1 -bromo-4-[(chloromethyl)sulfonyl]benzene), cloquintocet-mexyl, cyometrinil, cyprosulfonamide, dichlormid, 4-(dichloroacetyl)-1-oxa-4-azospiro[4.5]decane (MON 4660), 2-(dichloromethyl)-2-methyl-1,3-dioxolane (MG 191), dicyclonon, dietholate, fenchlorazole-ethyl, fenclorim, flurazole, fluxofenim, furilazole, isoxadifen-ethyl, mefenpyr-diethyl, mephenate, methoxyphenone ((4-methoxy-3-methylphenyl)(3-methylphenyl)-methanone), naphthalic anhydride (1,8-naphthalic anhydride) and oxabetrinil to further increase safety to certain crops. In some instances, these additional safeners may interact synergistically with component (a) to provide a greater than additive effect in safening herbicide component (b).

Of note is a composition comprising component (a) (in an antidotally effective amount), component (b) (in a herbicidally effective amount), at least one additional active ingredient selected from the group consisting of other herbicides and herbicide safeners (in an effective amount), and at least one component selected from the group consisting of surfactants, solid diluents and liquid diluents.

Component (a) and component (b) together often provide sufficient weed control efficacy and crop safety to obviate need to include other biologically active compounds or agents, such as other herbicides and/or safeners. Thus of note is a combination, mixture or composition comprising components (a) and/or (b) according to the present invention not comprising safeners other than component (a) and herbicides other than component (b). Also of note is a combination, mixture or composition comprising components (a) and/or (b) according to the present invention not comprising biologically active compounds or agents other than components (a) and (b). Therefore an embodiment of note is a combination, mixture or composition consisting essentially of, or consisting of, an antidotally effective amount of component (a) and component (b) (i.e. in a herbicidally effective amount) as the (only) active ingredients.

### BIOLOGICAL EXAMPLES OF THE INVENTION

The following Tests demonstrate the efficacy of the compound of Formula 1 (identified as Compound 1) in combination with various herbicides to reduce the phytotoxicity of the herbicides to crops while maintaining the ability of herbicides to control certain agronomically important weeds. The safening effect of Compound 1 is not limited, however, to the herbicide combinations and crops exemplified.

For all of the following biological tests, plant response ratings were based on a 0-100 scale where zero is growth equivalent to that of untreated plants (no plant response) and 100 represents no additional growth occurring after herbicide treatment.

Although the Colby Equation (Colby, S. R., “Calculating Synergistic and Antagonistic Responses of Herbicide Combinations”, Weeds 1967, 15, 20-22) can be used to calculate expected plant responses to herbicide combinations, this equation is not needed to determine the expected plant response to a combination of a herbicide with a chemical compound having no herbicidal effect. In the following tests, Compound 1 at the application rates used caused no phytotoxicity to any of the plant species. Accordingly, the phytotoxicity expected from combinations of herbicides with Compound 1 is simply the phytotoxicity of the herbicides alone. Phytotoxicity observed for combination with Compound 1 to be less than the phytotoxicity of the herbicide alone indicates that Compound 1 exhibited an effect that can be variously described as antagonism, antidoting or safening.

### Test A

Pioneer 39K40 hybrid maize used in this test (and also Tests B and C) is particularly sensitive to herbicides that inhibit the acetohydroxy acid synthase enzyme. Herbicide mixtures were dissolved/dispersed in a non-phytotoxic liquid carrier and were sprayed postemergence to Pioneer 39K40 hybrid maize (Zea mays L. spp. indentata Sturt.) in the third collar growth stage (extended leaf height was 50-60 cm). Treated plants were grown under greenhouse conditions for two weeks before visual evaluations of plant responses were recorded. The plant response ratings are summarized in Table A. Plants treated with 125 g ai/ha of Compound 1 alone exhibited no injury.

TABLE A
Pioneer 39K40 Hybrid Maize Responses to Postemergence Treatments
of Thifensulfuron-methyl, Rimsulfuron or Metsulfuron-methyl
Alone and in Combination with Compound 1

| | | Observed Response | |
|---|---|---|---|
| Herbicide | | | Herbicide mixture |
| | Dose | Herbicide | with Compound 1 |
| | (g ai/ha) | alone | (125 g ai/ha) |
| Thifensulfuron-methyl | 8 | 73 | 10 |
| Rimsulfuron | 35 | 92 | 7 |
| Metsulfuron-methyl | 2 | 99 | 65 |

The results in Table A show Compound 1 remarkably improved maize tolerance to the three sulfonylurea herbicides: thifensulfuron-methyl, rimsulfuron and metsulfuron-methyl.

### Test B

Herbicide mixtures were dissolved/dispersed in a non-phytotoxic liquid carrier and were sprayed postemergence to Pioneer 39K40 hybrid maize (Zea mays L. spp. indentata Sturt.) in the third collar growth stage (extended leaf height was 50-60 cm). Treated plants were grown under greenhouse conditions for two weeks before visual evaluations of plant responses were recorded. The plant response ratings are summarized in Table B. Plants treated with 125 g ai/ha of Compound 1 alone exhibited no injury.

TABLE B
Pioneer 39K40 Hybrid Maize Responses to Postemergence
Treatments of Rimsulfuron or Thifensulfuron-methyl
Alone or in Combination with Compound 1

| | | Observed Response | | | | | |
|---|---|---|---|---|---|---|---|
| | | | Herbicide mixture with | | | | |
| Herbicide | | Herbicide | Compound 1 (g ai/ha) | | | | |
| | Dose (g ai/ha) | alone | 16 | 31 | 62 | 125 | 250 |
| Rimsulfuron | 35 | 62 | 42 | 18 | 15 | 3 | 0 |
| Thifensulfuron- | 8 | 45 | 10 | 3 | 3 | 0 | 0 |
| methyl | | | | | | | |

The results in Table B show Compound 1 at application rates even as low as 16 g ai/ha, the lowest dose applied in this test, remarkably reduced maize phytotoxicity (better crop safety) caused by postemergence applications of thifensulfuron-methyl and rimsulfuron.

### Test C

Herbicide mixtures were dissolved/dispersed in a non-phytotoxic liquid carrier and were sprayed postemergence to Pioneer 39K40 hybrid maize (Zea mays L. spp. indentata Sturt.) in the third collar growth stage (extended leaf height was 40-60 cm). Treated plants were grown under greenhouse conditions for two weeks before visual evaluations of plant responses were recorded. The plant response ratings are summarized in Table C. Plants treated with 125 g ai/ha of Compound 1 alone exhibited no injury.

TABLE C
Pioneer 39K40 Hybrid Maize Responses to Postemergence
Treatments of Acetohydroxy acid synthase-inhibiting
Herbicides Alone and in Combination with Compound 1

| | | Observed Response | |
|---|---|---|---|
| Herbicide | | | Herbicide mixture |
| | Dose | Herbicide | with Compound 1 |
| | (g ai/ha) | alone | (125 g ai/ha) |
| Azimsulfuron | 17.5 | 100 | 100 |
| Bensulfuron-methyl | 17.5 | 80 | 7 |
| Chlorimuron-ethyl | 8 | 96 | 53 |
| Chlorsulfuron | 8 | 100 | 100 |
| Flucarbazone-sodium | 17.5 | 100 | 100 |
| Flumetsulam | 35 | 83 | 43 |
| Flupyrsulfuron-methyl-sodium | 8 | 82 | 17 |
| Halosulfuron-methyl | 17.5 | 37 | 10 |
| Imazamethabenz | 17.5 | 100 | 100 |
| Imazapyr | 17.5 | 100 | 100 |
| Imazaquin | 17.5 | 100 | 100 |
| Imazethapyr | 17.5 | 100 | 100 |
| Iodosulfuron-methyl | 17.5 | 100 | 57 |
| Mesosulfuron-methyl | 17.5 | 100 | 100 |
| Primisulfuron-methyl | 70 | 50 | 40 |
| Propoxycarbazone-sodium | 35 | 100 | 100 |
| Prosulfuron | 17.5 | 10 | 7 |
| Pyrithiobac-sodium | 17.5 | 100 | 100 |
| Rimsulfuron | 35 | 90 | 43 |
| Sulfometuron-methyl | 8 | 100 | 100 |
| Triasulfuron | 8 | 83 | 40 |
| Tribenuron-methyl | 8 | 100 | 77 |
| Triflusulfuron-methyl | 35 | 100 | 100 |

The results in Table C show Compound 1 at 125 g ai/ha remarkably reduced maize phytotoxicity (better crop safety) caused by postemergence applications of bensulfuron-methyl, chlorimuron-ethyl, flumetsulam, flupyrsulfuron-methyl-sodium, halosulfuron-methyl, iodosulfuron-methyl, rimsulfuron, triasulfuron and tribenuron-methyl.

### Test D

Cultivated sorghum varieties are generally very sensitive to acetohydroxy acid synthase-inhibiting herbicides such as rimsulfuron. To impart tolerance in sorghum hybrids WL09-6001 and WL09-6002 used in this test, plant breeders introduced a gene for acetohydroxy acid synthase (also known as acetolactate synthase) resistant to inhibition by certain acetohydroxy acid synthase-inhibiting herbicides, by breeding starting from a wild Sorghum genotype containing the resistance gene (see U.S. Patent Publication US 2008/0216187 A1).

Herbicide mixtures were formulated, dissolved/dispersed in water containing 1% crop oil concentrate, and sprayed postemergence to sorghum (Sorghum bicolor (L.) Moench) in the third collar growth stage (extended leaf height is 10-20 cm). Treated plants were grown under greenhouse conditions for two weeks before visual evaluations of plant responses were recorded. The plant response ratings are summarized in Table D. Plants treated with 125 g ai/ha of Compound 1 alone exhibited no injury.

TABLE D
Sorghum Responses to Postemergence Treatments of
Rimsulfuron Alone and in Combination with Compound 1

| | | | Observed Response | |
|---|---|---|---|---|
| | Herbicide | | | Herbicide mixture |
| Sorghum | | Dose | Herbicide | with Compound 1 |
| hybrid | | (g ai/ha) | alone | (125 g ai/ha) |
| WL09-6001 | Rimsulfuron | 8 | 0 | 0 |
| WL09-6001 | Rimsulfuron | 16 | 0 | 0 |
| WL09-6001 | Rimsulfuron | 32 | 17 | 0 |
| WL09-6001 | Rimsulfuron | 64 | 40 | 13 |
| WL09-6002 | Rimsulfuron | 8 | 0 | 0 |
| WL09-6002 | Rimsulfuron | 16 | 17 | 0 |
| WL09-6002 | Rimsulfuron | 32 | 57 | 3 |
| WL09-6002 | Rimsulfuron | 64 | 73 | 70 |

The results in Table D show Compound 1 at 125 g ai/ha remarkably reduced the phytotoxic response of sorghum hybrids having some ALS herbicide tolerance (increased crop safety) to postemergence applications of rimsulfuron.

### Test E

Herbicide mixtures were formulated, dissolved/dispersed in water containing 0.25% non-ionic surfactant, sprayed postemergence to the crops: winter wheat (Triticum aestivum L.), spring wheat (Triticum aestivum L.), winter barley (Hordeum vulgare L.) and spring barley (Hordeum vulgare L.), and the weeds: blackgrass (Alopecurus myosuroides Huds.), lambsquarters (Chenopodium album L.) and pigweed (Amaranthus retroflexus L.). Treated plants were grown under greenhouse conditions for two weeks before visual evaluations of plant responses were recorded. The plant response ratings are summarized in Table E. Plants treated with 125 g ai/ha of Compound 1 alone exhibited no injury.

TABLE E
Wheat, Barley, and Weed Responses to Postemergence
Treatments of Flupyrsulfuron-methyl (sodium salt)
Alone and in Combination with Compound 1

| | | | Observed Response | |
|---|---|---|---|---|
| | Herbicide | | | Herbicide mixture |
| | | Dose | Herbicide | with Compound 1 |
| Plant species | | (g ai/ha) | alone | (125 g ai/ha) |
| Winter wheat | Flupyrsulfuron- | 10 | 17 | 0 |
| | methyl | | | |
| Winter wheat | Flupyrsulfuron- | 20 | 18 | 0 |
| | methyl | | | |
| Spring wheat | Flupyrsulfuron- | 10 | 18 | 3 |
| | methyl | | | |
| Spring wheat | Flupyrsulfuron- | 20 | 22 | 0 |
| | methyl | | | |
| Winter barley | Flupyrsulfuron- | 10 | 42 | 12 |
| | methyl | | | |
| Winter barley | Flupyrsulfuron- | 20 | 42 | 27 |
| | methyl | | | |
| Spring barley | Flupyrsulfuron- | 10 | 47 | 23 |
| | methyl | | | |
| Spring barley | Flupyrsulfuron- | 20 | 53 | 43 |
| | methyl | | | |
| Blackgrass | Flupyrsulfuron- | 10 | 98 | 99 |
| | methyl | | | |
| Blackgrass | Flupyrsulfuron- | 20 | 99 | 99 |
| | methyl | | | |
| Lambsquarters | Flupyrsulfuron- | 10 | 78 | 83 |
| | methyl | | | |
| Lambsquarters | Flupyrsulfuron- | 20 | 87 | 87 |
| | methyl | | | |
| Pigweed | Flupyrsulfuron- | 10 | 100 | 96 |
| | methyl | | | |
| Pigweed | Flupyrsulfuron- | 20 | 99 | 97 |
| | methyl | | | |

The results in Table E show Compound 1 at 125 g ai/ha remarkably reduced phytotoxic responses of winter and spring wheat and winter and spring barley to flupyrsulfuron-methyl as its sodium salt (i.e. flupyrsulfuron-methyl-sodium) (better crop safety) while allowing the herbicide to maintain control of blackgrass, lambsquarters and pigweed.

### Test F

Herbicide mixtures were formulated, dissolved/dispersed in water, and sprayed preemergence to the crops: winter wheat (Triticum aestivum L.) and winter barley (Hordeum vulgare L.), and the weed: blackgrass (Alopecurus myosuroides Huds). Treated plants were grown under greenhouse conditions for three weeks before visual evaluations of plant responses were recorded. The plant response ratings are summarized in Table F. Plants treated with 125 g ai/ha of Compound 1 alone exhibited no injury.

TABLE F
Wheat, Barley, and Blackgrass Responses to Preemergence
Treatments of Flupyrsulfuron-methyl (sodium salt)
Alone or in Combination with Compound 1

| | | | Observed Response | |
|---|---|---|---|---|
| | Herbicide | | | Herbicide mixture |
| | | Dose | Herbicide | with Compound 1 |
| Plant species | | (g ai/ha) | alone | (125 g ai/ha) |
| Winter wheat | Flupyrsulfuron- | 32 | 30 | 10 |
| | methyl | | | |
| Winter wheat | Flupyrsulfuron- | 64 | 40 | 33 |
| | methyl | | | |
| Winter barley | Flupyrsulfuron- | 32 | 75 | 40 |
| | methyl | | | |
| Winter barley | Flupyrsulfuron- | 64 | 90 | 35 |
| | methyl | | | |
| Blackgrass | Flupyrsulfuron- | 32 | 95 | 90 |
| | methyl | | | |
| Blackgrass | Flupyrsulfuron- | 64 | 95 | 97 |
| | methyl | | | |

The results in Table F show Compound 1 at 125 g ai/ha unexpectedly and surprisingly reduced phytotoxic responses of winter wheat and winter barley to flupyrsulfuron-methyl as its sodium salt (i.e. flupyrsulfuron-methyl-sodium) (better crop safety) while allowing the herbicide to maintain equivalent control of blackgrass.

### Test G

Plants of the turf grass species: zoysia (Zoysia japonica Steud.), bermudagrass (Cynodon dactylon (L.) Pers.), tall fescue (Festuca arundinacea Shreib.), creeping bentgrass (Agrostis stoonoifera L.), perennial ryegrass (Lolium perenne L.) and hard fescue (Festuca species) were grown under greenhouse conditions for four months. Plants were clipped as needed to plant heights of 5-10 cm. Weeds typically found in turf: annual bluegrass (Poa annua L.), common chickweed (Stellaria media (L.) Vill.), large crabgrass (Digitaria sanguinales (L.) Scop.), dandelion (Taraxacum officinale Weber in Wiggers), goosegrass (Eleusine indica (L.) Gaertn.), henbit (Lamium amplexicaule L.), venice mallow (Hibiscus trionium L.) and purple nutsedge (Cyperus rotundus L.) were also grown under greenhouse conditions so that plants were 5-20 cm tall when they were treated. Herbicide mixtures were formulated, dissolved/dispersed in water containing 0.25% non-ionic surfactant, and sprayed postemergence to these turf grasses and weeds. Treated plants were grown under greenhouse conditions for three weeks before visual evaluations of plant responses were recorded. The plant response ratings are summarized in Table G. Plants treated with 125 g ai/ha of Compound 1 alone exhibited no injury.

TABLE G
Turf grass and Weed Responses to Postemergence Treatments of Nicosulfuron, Metsulfuron-
methyl or Aminocyclopyrachlor Alone or in combination with Compound 1

| | | | Observed Response | |
|---|---|---|---|---|
| | Herbicide | | | Herbicide mixture |
| | | Dose | Herbicide | with Compound 1 |
| Plant species | | (g ai/ha) | alone | (125 g ai/ha) |
| Zoysia grass | Nicosulfuron | 80 | 25 | 0 |
| Zoysia grass | Metsulfuron-methyl | 80 | 0 | 0 |
| Zoysia grass | Aminocyclopyrachlor-potassium | 200 | 30 | 0 |
| Bermudagrass | Nicosulfuron | 80 | 0 | 0 |
| Bermudagrass | Metsulfuron-methyl | 80 | 0 | 0 |
| Bermudagrass | Aminocyclopyrachlor-potassium | 200 | 20 | 0 |
| Tall fescue | Nicosulfuron | 80 | 60 | 60 |
| Tall fescue | Metsulfuron-methyl | 80 | 40 | 0 |
| Tall fescue | Aminocyclopyrachlor-potassium | 200 | 0 | 0 |
| Hard fescue | Nicosulfuron | 80 | 60 | 30 |
| Hard fescue | Metsulfuron-methyl | 80 | 0 | 0 |
| Hard fescue | Aminocyclopyrachlor-potassium | 200 | 0 | 0 |
| Creeping bentgrass | Nicosulfuron | 80 | 80 | 88 |
| Creeping bentgrass | Metsulfuron-methyl | 80 | 0 | 0 |
| Creeping bentgrass | Aminocyclopyrachlor-potassium | 200 | 20 | 0 |
| Perennial ryegrass | Nicosulfuron | 80 | 80 | 50 |
| Perennial ryegrass | Metsulfuron-methyl | 80 | 50 | 0 |
| Perennial ryegrass | Aminocyclopyrachlor-potassium | 200 | 0 | 0 |
| Annual bluegrass | Nicosulfuron | 80 | 100 | 100 |
| Annual bluegrass | Metsulfuron-methyl | 80 | 80 | 50 |
| Annual bluegrass | Aminocyclopyrachlor-potassium | 200 | 20 | 0 |
| Chickweed | Nicosulfuron | 80 | 100 | 100 |
| Chickweed | Metsulfuron-methyl | 80 | 100 | 100 |
| Chickweed | Aminocyclopyrachlor-potassium | 200 | 100 | 100 |
| Large crabgrass | Nicosulfuron | 80 | 100 | 100 |
| Large crabgrass | Metsulfuron-methyl | 80 | 60 | 0 |
| Large crabgrass | Aminocyclopyrachlor-potassium | 200 | 80 | 70 |
| Dandelion | Nicosulfuron | 80 | 100 | 100 |
| Dandelion | Metsulfuron-methyl | 80 | 100 | 100 |
| Dandelion | Aminocyclopyrachlor-potassium | 200 | 100 | 100 |
| Goosegrass | Nicosulfuron | 80 | 80 | 90 |
| Goosegrass | Metsulfuron-methyl | 80 | 50 | 0 |
| Goosegrass | Aminocyclopyrachlor-potassium | 200 | 50 | 0 |
| Henbit | Nicosulfuron | 80 | 100 | 100 |
| Henbit | Metsulfuron-methyl | 80 | 100 | 100 |
| Henbit | Aminocyclopyrachlor-potassium | 200 | 100 | 100 |
| Venice mallow | Nicosulfuron | 80 | 40 | 80 |
| Venice mallow | Metsulfuron-methyl | 80 | 100 | 100 |
| Venice mallow | Aminocyclopyrachlor-potassium | 200 | 100 | 98 |
| Purple nutsedge | Nicosulfuron | 80 | 80 | 80 |
| Purple nutsedge | Metsulfuron-methyl | 80 | 60 | 20 |
| Purple nutsedge | Aminocyclopyrachlor-potassium | 200 | 40 | 40 |

The results in Table G show Compound 1 at 125 g ai/ha remarkably reduced phytotoxic responses of select turf grasses to nicosulfuron, metsulfuron-methyl, and/or aminocyclopyrachlor while allowing these herbicides to maintain their ability to control weeds typically found in turf.

### Test H

Herbicide mixtures were formulated, dissolved/dispersed in water containing 0.25% non-ionic surfactant, and sprayed postemergence at the 2-leaf growth stage to a sunflower variety (Helianthus annuus L. var. Pioneer 63N82) bred for resistance to tribenuron-methyl. Treated plants were grown under greenhouse conditions for two weeks before visual evaluations of plant responses were recorded. The plant response ratings are summarized in Table H. Plants treated with 125 g ai/ha of Compound 1 alone exhibited no injury.

TABLE H
Tribenuron-tolerant Sunflower Responses to Postemergence
Treatments of Tribenuron-methyl or Sulfometuron-methyl
Alone or in Combination with Compound 1

| | | Observed Response | |
|---|---|---|---|
| Herbicide | | | Herbicide mixture |
| | Dose | Herbicide | with Compound 1 |
| | (g ai/ha) | alone | (125 g ai/ha) |
| Tribenuron-methyl | 4 | 0 | 0 |
| Tribenuron-methyl | 8 | 0 | 0 |
| Tribenuron-methyl | 16 | 0 | 0 |
| Tribenuron-methyl | 31 | 10 | 0 |
| Tribenuron-methyl | 62 | 20 | 0 |
| Sulfometuron-methyl | 4 | 27 | 7 |
| Sulfometuron-methyl | 8 | 30 | 3 |
| Sulfometuron-methyl | 16 | 33 | 3 |
| Sulfometuron-methyl | 31 | 37 | 7 |
| Sulfometuron-methyl | 62 | 40 | 7 |

The results in Table H show Compound 1 at 125 g ai/ha remarkably further increased the tolerance of this sunflower variety to tribenuron-methyl, so that no injury was noted even at an application rate of 62 g/ha of tribenuron-methyl. Furthermore Compound 1 at 125 g ai/ha reduced to a very low level the phytotoxic response to sulfometuron-methyl, to which this sunflower variety is ordinarily less tolerant.

### Test I

Herbicide mixtures were formulated, dissolved/dispersed in water containing 0.25% non-ionic surfactant, and sprayed postemergence to the crop: soybean (Glycine max (L.) Merr.) at the 2-leaf growth stage and to weeds: lambsquarters (Chenopodium album L.) and velvetleaf (Abutilon theophrasti Medik.). Weed species were 5-10 cm tall when treated. Treated plants were grown under greenhouse conditions for two weeks before visual evaluations of plant responses were recorded. The plant response ratings are summarized in Table I. Plants treated with 125 g ai/ha of Compound 1 alone exhibited no injury.

TABLE I
Soybean and Broadleaf Weed Responses to Postemergence
Treatments of Thifensulfuron-methyl Alone
or in Combination with Compound 1

| | | | Observed Response | |
|---|---|---|---|---|
| | Herbicide | | | Herbicide mixture |
| | | Dose | Herbicide | with Compound 1 |
| Plant species | | (g ai/ha) | alone | (125 g ai/ha) |
| Soybean | Thifensulfuron- | 4 | 25 | 15 |
| | methyl | | | |
| Soybean | Thifensulfuron- | 8 | 53 | 30 |
| | methyl | | | |
| Lambsquarters | Thifensulfuron- | 4 | 98 | 99 |
| | methyl | | | |
| Lambsquarters | Thifensulfuron- | 8 | 100 | 100 |
| | methyl | | | |
| Velvetleaf | Thifensulfuron- | 4 | 99 | 99 |
| | methyl | | | |
| Velvetleaf | Thifensulfuron- | 8 | 100 | 100 |
| | methyl | | | |

The results in Table I show Compound 1 at 125 g ai/ha remarkably reduced phytotoxic responses of soybean to thifensulfuron-methyl (better crop safety) while allowing thifensulfuron-methyl to selectively control the weed species.

### Test J

Herbicide mixtures were formulated, dissolved/dispersed in water containing 0.25% non-ionic surfactant, and sprayed postemergence to sugarcane (Saccharum officinarum L.) approximately 20-40 cm tall (extended leaf height). This test was conducted under field conditions. Visual evaluations of plant responses were recorded four weeks after the plants were treated. The plant response ratings are summarized in Table J. Plants treated with 140 g ai/ha of Compound 1 alone exhibited no injury.

TABLE J
Sugarcane Responses to Postemergence Treatments of Various
Herbicices Alone and in Combination with Compound 1

| | | Observed Response | | |
|---|---|---|---|---|
| | | | Herbicide mixture | |
| Herbicide | | | with Compound 1 | |
| | Dose | Herbicide | (g ai/ha) | |
| | (g ai/ha) | alone | 70 | 140 |
| Sulfometuron-methyl | 30 | 60 | 45 | 30 |
| Metsulfuron-methyl | 15 | 50 | 35 | 30 |
| Aminocyclopyrachlor- | 45 | 5 | 5 | 0 |
| potassium | | | | |
| Metsulfuron-methyl + | 15 + 45 | 50 | 35 | 20 |
| Aminocyclopyrachlor- | | | | |
| potassium | | | | |

The results in Table I show Compound 1 at 70 and 140 g ai/ha remarkably reduced phytotoxic responses (better crop safety) of sugarcane to sulfometuron-methyl and metsulfuron-methyl. Even in the absence of Compound 1, aminocyclopyrachlor at 45 g ai/ha caused little injury to sugarcane. However, Compound 1 significantly reduced injury from the combination of aminocyclopyrachlor with metsulfuron-methyl.

### Test K

Herbicide mixtures were formulated, dissolved/dispersed in water containing 0.25% non-ionic surfactant, and sprayed postemergence to the pasture grasses: Surinam grass (Brachiaria decumbens Stapf), palisade grass (Brachiaria brizantha (Hochst. ex A. Rich) Stapf) and Alexandergrass (Brachiaria plantaginea (Link) A. S. Hitchc.) approximately 10-30 cm tall (extended leaf height). This test was conducted under field conditions. Visual evaluations of plant responses were recorded four weeks after the plants were treated. The plant response ratings are summarized in Table K. Plants treated with 140 g ai/ha of Compound 1 alone exhibited no injury.

TABLE K
Pasture grass Responses to Postemergence Treatments of Sulfometuron-
methyl Alone and in Combination with Compound 1

| | | | Observed Response | | |
|---|---|---|---|---|---|
| | | | | Herbicide mixture | |
| | Herbicide | | | with Compound 1 | |
| | | Dose | Herbicide | (g ai/ha) | |
| Plant species | | (g ai/ha) | alone | 70 | 140 |
| Surinam grass | Sulfometuron- | 30 | 50 | 45 | 30 |
| | methyl | | | | |
| Palisade grass | Sulfometuron- | 30 | 45 | 40 | 20 |
| | methyl | | | | |
| Alexandergrass | Sulfometuron- | 30 | 50 | 45 | 30 |
| | methyl | | | | |

The results in Table K show Compound 1 at 70 and 140 g ai/ha significantly reduced phytotoxic responses of several species of pasture grasses to sulfometuron-methyl (better crop safety).

What is claimed is:

1. A herbicidal mixture comprising (a) at least one compound selected from N-(aminocarbonyl)-2-methylbenzenesulfonamide and salts thereof, and (b) at least one herbicide compound selected from (b1) acetohydroxy acid synthase inhibitors, (b2) auxin mimics, (b3) 4-hydroxyphenyl-pyruvate dioxygenase inhibitors, and salts of compounds of (b1) through (b3).

2. The herbicidal mixture of claim 1 wherein component (b) comprises at least one herbicide compound selected from sulfonylurea herbicides.

3. The herbicide mixture of claim 2 wherein component (b) comprises at least one herbicide compound selected from chlorimuron-ethyl, flupyrsulfuron-methyl, metsulfuron-methyl, nicosulfuron, rimsulfuron, sulfometuron-methyl and thifensulfuron-methyl, and salts thereof.

4. The herbicide mixture of claim 3 wherein component (b) comprises at least one herbicide compound selected from nicosulfuron and rimsulfuron, and salts thereof.

5. The herbicide mixture of claim 4 wherein component (b) further comprises dicamba or a salt thereof.

6. A herbicidal composition comprising a herbicidal mixture of claim 1 and at least one component selected from the group consisting of surfactants, solid diluents and liquid diluents.

7. A method for controlling the growth of undesired vegetation comprising contacting the locus of the undesired vegetation with a herbicidally effective amount of the herbicidal mixture of claim 1.

8. The method of claim 7 wherein the locus of the undesired vegetation is a crop.

9. The method of claim 8 wherein the crop is selected from wheat, barley, maize, sorghum, soybeans, sunflower, sugarcane, pasture grasses and turf grasses.

10. A herbicide safener composition comprising at least one compound selected from N-(aminocarbonyl)-2-methylbenzenesulfonamide and salts thereof and at least one component selected from the group consisting of surfactants, solid diluents and liquid diluents.

11. The herbicide safener composition of claim 10 comprising at least one component selected from film formers and adhesive agents.

12. A method for protecting a plant from herbicide injury comprising applying an antidotally effective amount of at least one compound selected from N-(aminocarbonyl)-2-methylbenzenesulfonamide and salts thereof to the plant or the locus of the plant.

13. A method for protecting a propagule or a plant grown therefrom from herbicide injury comprising treating the propagule with an antidotally effective amount of at least one compound selected from N-(aminocarbonyl)-2-methylbenzenesulfonamide and salts thereof.

14. A propagule treated with an antidotally effective amount of at least one compound selected from N-(aminocarbonyl)-2-methylbenzenesulfonamide and salts thereof.

15. The propagule of claim 14 which is a seed.
